(19) United States
(12) Patent Application Publication
(10) Pub. No.: US 2023/0250286 A1
(43) Pub. Date: Aug. 10, 2023

(54) THERMOPLASTIC COMPOSITE COMPOSITIONS WITH ADVANCED INTEGRATED PROPERTIES

(71) Applicant: Suncolor Corporation, North Canton, OH (US)

(72) Inventor: David A. SMETANA, North Canton, OH (US)

(21) Appl. No.: 17/634,967

(22) PCT Filed: Aug. 12, 2020
(86) PCT No.: PCT/US2020/046036

§ 371 Date: Feb. 12, 2022

Related U.S. Application Data
(60) Provisional application No. 62/885,601, filed on Aug. 12, 2019.

(51) Int. Cl. C08L 83/06; C08G 77/18; C08K 3/22

(52) U.S. Cl. CPC C08L 83/06; C08G 77/18; C08K 3/22; C08K 2003/2227; C08K 2003/2244; C08L 2201/50

(57) ABSTRACT

A molding composition comprising (i) a thermoplastic resin; and (ii) a polysiloxane, where the polysiloxane includes phenyl substituents.

This application is a national-stage application of PCT/US2020/046036 filed on Aug. 12, 2020, which claims the benefit of U.S. Provisional Application No. 62/885,601 filed on Aug. 12, 2019, which are incorporated herein by reference.

### FIELD OF THE INVENTION

Embodiments of the invention are directed toward molding compositions that include a thermoplastic resin and a phenyl-containing polysiloxane.

### BACKGROUND OF THE INVENTION

There is a growing need for new and improved organic and organic, inorganic composite thermoplastics to satisfy the need of existing and emerging technologies, applications, and products. It is an object of this invention to provide thermoplastic molding material compositions with highly integrated properties including transparency, high thermal stability, improved geometrical stability, lower coefficients of thermal expansion, increased glass transition (Tg) temperatures, a broader Tg range, low mold-in stress, low birefringence in molded and injection molded articles. For example, the commercial and industrial applications for such an advanced thermoplastic molding material include numerous electrical, electronic, and optoelectronic related products (e.g. LEDs, VSCELs, LiDAR, self-driving instrumentation and controls) efficient use of light for illumination and for the transmission of information with light within the consumer, industrial. automotive, aviation, military, and medical industries. Articles molded from the novel composite thermoplastics of this invention, including lenses, micro-lenses, light diffusers, light homogenizers, reflectors, structural components, can be used in devices in the consumer market for applications such as lighting, proximity sensors, face identification, 3D cameras in cell phones, home automation, security, controls for electronics and appliances. In the industrial market, applications for molded articles include use in devices for 3D vision, safety sensors, motion control, robotics in factories and warehouses, drones for surveillance, delivery applications, self-driving applications, including gesture recognition, driver monitoring, collision control and pedestrian and bicycle monitoring. In aviation, molded articles produced from the novel thermoplastic compositions of this invention, include use in devices for image distortion corrections, depth perception, and time of flight/destination. In the medical industry, molded articles produced from the novel thermoplastic compositions of this invention, include can be used in devices and instrumentation to improve 3D imaging such as traditional x-ray, MRI imaging, and low light laser therapy.

Organic, inorganic thermoplastic composites, have wide-ranging applications including fiber composites, sporting goods, jet engine parts, automotive parts, compressed gas cylinders, and compositions. One of the drivers for exploring the use of inorganic thermoplastic modification is the enhanced strength/stiffness that is provided to composite parts using such resins, allowing for production of light-weight composite parts.

The increased use of thermoplastics in high temperature environments, such as those encountered in aerospace and transportation applications, including high temperature solder reflow processing, has re-invigorated research related to thermal improvements of organic, inorganic composites to mechanical property retention and versatile light transmission performance.

### SUMMARY OF INVENTION

One or more embodiments of the present invention provide a molding composition comprising (i) a thermoplastic resin; and (ii) a polysiloxane, where the polysiloxane includes phenyl substituents.

Yet other embodiments of the present invention provide an article molded from the molding composition comprising (i) a thermoplastic resin; and (ii) a polysiloxane, where the polysiloxane includes phenyl substituents.

Still other embodiments of the present invention provide a method for forming a molded article, the method comprising thermally molding the molding composition comprising (i) a thermoplastic resin; and (ii) a polysiloxane, where the polysiloxane includes phenyl substituents.

### DESCRIPTION OF THE DRAWINGS

FIG. 1 is a photograph of an injection molded plaque according to aspects of the invention.

FIG. 2 is a photograph of an injection molded plaque according to aspects of the invention.

FIG. 3 is a photograph of an injection molded plaque according to aspects of the invention.

FIG. 4 is a photograph of an injection molded plaque according to aspects of the invention.

FIG. 5 is a photograph of an injection molded plaque according to aspects of the invention.

FIG. 6 is a photograph of an injection molded plaque according to aspects of the invention.

FIG. 7 is a photograph of a solder reflow oven and set up.

FIG. 8 is a TGA graph of compositions according to aspects of the invention.

FIG. 9 is a graph of luminous transmission of compositions according to aspects of the invention.

FIG. 10 is a graph of luminous transmission of compositions according to aspects of the invention.

FIG. 11 is a TMA graph of compositions according to aspects of the invention.

FIG. 12 is a TMA graph of compositions according to aspects of the invention.

FIG. 13 is a TMA graph of compositions according to aspects of the invention.

FIG. 14 is a TMA graph of compositions according to aspects of the invention.

### DETAILED DESCRIPTION OF ILLUSTRATIVE EMBODIMENTS

Embodiments of the invention are based, at least in part, on the discovery of molding compositions that include a thermoplastic resin and a phenyl-containing silicone. It has surprisingly been discovered that inclusion of a phenyl-containing silicone, especially at relatively low loadings, into a composition including a thermoplastic resin offers several unexpected advantages including increased glass transition temperature and lower coefficient of thermal expansion. In certain embodiments, the thermoplastic resin is a high-temperature thermoplastic resin, and when combined with a phenyl-containing silicone, the resulting compositions have attractive properties for a variety of high-temperature applications. Further, the molding compositions can include a variety of additives to form compositions targeted for particular uses, and it believed that the phenyl-containing silicone may interact synergistically with the one or more additives to provide advantageous results.

As indicated above, the compositions of this invention, which may be referred to as molding compositions or molding materials or composite molding compositions, or composite compositions, include a thermoplastic resin and a phenyl-containing silicone. Additionally, the compositions of this invention may also include a zirconate, in other embodiments a titanate, in other embodiments an inorganic particulate, in other embodiments a silsesquioxane, in other embodiments a biphenol, in other embodiments a cycloaliphatic epoxide, and in other embodiments two or more of a zirconate, a titanate, an inorganic particulate, a silsesquioxane, a biphenol, and a cycloaliphatic epoxide.

### Thermoplastic Resins

The thermoplastic resins, which may also be referred to as thermoplastic polymers, that are used in this invention may include conventional thermoplastic polymers, which flow when heated and harden or solidify upon cooling. The skilled person understands that thermoplastic resins do not set (i.e. irreversibly crosslink) upon heating. In one or more embodiments, useful thermoplastic polymers are soluble in low-boiling organic solvents.

In one or more embodiments, the thermoplastic resins exhibit a glass transition temperature (Tg), which may be determined by differential scanning calorimetry (DSC), of greater than 50° C., in other embodiments greater than 80° C., in other embodiments greater than 100° C., in other embodiments greater than 120° C., in other embodiments greater than 130° C., and in other embodiments greater than 150° C. In these or other embodiments, the thermoplastic resins exhibit a melt temperature (Tm), which may be determined by differential scanning calorimetry (DSC), of greater than 120° C., in other embodiments greater than 150° C., in other embodiments greater than 180° C., in other embodiments greater than 200° C., in other embodiments greater than 220° C., and in other embodiments greater than 240° C. Unless otherwise stated, DSC values disclosed in this specification are reported pursuant to ASTM E1356. As the skilled person will understand, Tg can also be determined by thermomechanical analysis (TMA) pursuant to testing outlined in ASTM E831 and ASTM E1545. The skilled person also understands that Tg obtained from either DSC or TMA is generally consistent.

In one or more embodiments, useful thermoplastic resins include amorphous and semi-amorphous thermoplastics. As the skilled person understands, amorphous thermoplastic resins do not fully crystallize below the glass transition temperature. In these or other embodiments, the amorphous thermoplastic polymers may be partially crystalline thermoplastic polymers.

Suitable thermoplastic resins for use in the invention include, but are not limited to, polycarbonates, polysulfones, polyethersulfone, polyphenylsulfones, polyimides, polyetherimides, aromatic polyesters, and aromatic polyethers. Other suitable thermoplastic resins can be found in the Handbook of Thermoplastics (Plastics Engineering), Olagoke Olabisi, Kolapo Adewale, Dec. 22, 2015. Many useful thermoplastic resins are commercially available. For example, suitable polyimides and polyetherimide thermoplastics can be obtained from Sabic-IP under the trademarks of ULTEM® and EXTEM®. Suitable polycarbonates polymer thermoplastics can be obtained from Covestro LLC under the trademarks MakrolonⓇ and APEC®, and from Sabic IP under the trademarks of LEXAN®. Suitable polysulfones and polyphenylsulfones can be obtained from Solvay under the trademarks of Radel®, Udel®, and Veradel®, and from BASF under the trademark Ultrason®.

### Phenyl-Containing Silicones

In one or more embodiments, the phenyl-containing silicones employed in the practice of this invention, which may also be referred to as phenyl-containing polysiloxanes, include linear polysiloxanes with phenyl substituents. In particular embodiments, the phenyl-containing silicones are polydiphenylsiloxanes. In other particular embodiments, the phenyl-containing silicones are poly(phenyl)(methyl)siloxanes. In one or more embodiments, the phenyl-containing silicones include hydroxyl, siloxy or alkoxy end functionalities. In other embodiments, the phenyl-containing silicones include phenyl-containing silicone resins, which are formed by branched, cage-like oligosiloxanes with the general formula of RₙSiXₘO_{y}, where R is methyl or phenyl, and X is a functional group selected from hydrogen, hydroxyl, halogen and alkoxy.

In one or more embodiments, the phenyl-containing silicones have a molecular weight of greater than 1,000, in other embodiments greater than 800, in other embodiments greater than 1,200, and in other embodiments greater than 1,800, and in other embodiments greater than 2,200 g/mole. In these or other embodiments, the phenyl-containing silicones have a molecular weight of less than 6,000, in other embodiments less than 5,000, in other embodiments less than 4,000, in other embodiments less than 3,300, in other embodiments less than 3,000, and in other embodiments less than 2,800 g/mole. In one or more embodiments, the phenyl-containing silicones have a molecular weight of from about 800 to about 6,000, in other embodiments from about 1,000 to about 5,000, in other embodiments from about 1,200 to about 4,000, in other embodiments from about 1,500 to about 3,300 g/mole.

In one or more embodiments, the phenyl-containing silicones have a glass transition temperature (Tg), which can be determined by DSC, of greater than 35° C., in other embodiments greater than 40° C., in other embodiments greater than 45° C., in other embodiments greater than 50° C., in other embodiments greater than 55° C., in other embodiments greater than 60° C., and in other embodiments greater than 65° C.

In one or more embodiments, the phenyl-containing silicones employed in the practice of this invention are solids at normal temperature and pressure (NTP) (i.e. 20° C. and 1 atm). In one or more embodiments, the phenyl-containing silicones have a waterlike viscosity (generally a dynamic viscosity of less than 100 mPa·s) when heated above the melting range of 65 - 85° C. In one or more embodiments, these silicones flow at temperatures greater than 35° C., in other embodiments greater than 40° C., in other embodiments greater than 45° C., in other embodiments greater than 50° C., in other embodiments greater than 55° C., in other embodiments greater than 60° C., and in other embodiments greater than 65° C.

Preferred phenyl-containing silicones are clear, transparent high solids or high solids liquid silicone resins with less than 2% volatiles. Preferred phenyl-containing silicones and intermediates are those having a solid content greater than 99%, no solvent, a molecular weight (Mw) of 1,000 to 4,000, a hydroxy or silanol functionality, a refractive index between 1.40 and 1.65, and a melting range of 65-120° C.

Useful phenyl-containing silicones that may be employed in the practice of this invention are commercially available. For example, useful phenyl-containing silicones can be obtained from Wacker Corporation under the tradename SILRES, such as, but not limited to, SILRES 601, SILRES 603, SILRES 604, SILRES HP 2000, and SILRES HP 1250. One particularly useful phenyl-containing silicone is sold under the tradename SILRES 603, which is a solid flake or powder having a phenyl substituents, a solid content greater than 99%, no solvent, a molecular weight of 1,200 to 2,600, hydroxy functionality, an OH group content of 4.5% to 6.5%, a refractive index of 1.51 to 1.60, a Tg of >55° C., a melting range of 65-85° C.

Functionally, it is believed that the phenyl-containing silicones act as flow aids during thermal processing at temperatures (e.g. greater than 60° C.), and that the phenyl-containing silicones, after melting, cure, harden, or self-assemble in the presence of atmospheric moisture, or inherent internal moisture, heat, and time (e.g. 250° C. for ½ hour, 200° C. for 1 hour) or faster under higher temperatures up to 450° C., or shorter times and/or lower temperatures in the presence of organic or inorganic materials with OH or Si—O—H surface functionality such as metal oxides (e.g. phenols or phenolics, silica, alumina) and, or, catalysts (e.g. titanates, zirconates). Upon hardening from heat, it is believed that the silicones are thermally stable up to or greater than 450° C. measured by Thermogravimetric analysis. It is further believed that the phenyl-containing silicones interact or otherwise act as a synergist with the thermoplastic polymer (or other constituents) within the inventive compositions to raise the overall Tg of the composition. Additionally, it is believed that the phenyl-containing silicones interact or otherwise act as a synergist with the thermoplastic polymer (or other constituents) within the inventive compositions to lower the coefficient or thermal expansion (CTE) or coefficient of linear expansion (CTLE) of the composition.

### Zirconates

As indicated above, the composition of one or more embodiments of the invention may include a zirconate. In one or more embodiments, zirconates include organometallic complexes of zirconium. These compounds may include, for example, zirconium complexed by one or more organic compounds containing functional groups attached to a hydrocarbon linkage. The organic compounds may contain one or more, and in one embodiment, two or more functional groups. The functional groups may include one or more of a carbonyl group (═O), a thio substituent (═S), alkoxy substituent (--OR), thioalkyl (--SR,) amino (--NR₂), —NO₂, (=NOR), (=NSR) and/or (-N=NR), wherein R is hydrogen or a hydrocarbon group (e.g., alkyl or alkenyl) of 1 to about 10 carbon atoms. In one or more embodiments, the useful zirconates include coordinate zirconates.

Useful zirconates are commercially available. For example, coordinate zirconates are available under the tradenames KZ 55 from Kenrich. Other suitable zirconates are available from Dorf Zetal under the tradenames TYZOR 212, which is a zirconium chelate.

In one or more embodiments, tetramethyiguanidine (TMG) can be used with the zirconates at a dosage of 0.005% to 2% by the total weight of the silicone resins in the subject compositions as a curing synergist or accelerator.

Useful zirconates are generally known as described in U.S. Publication Nos. 2017/0260354, 2016/0115299, 2015/0225530, 2013/0005876, 2009/0258977, and 2009/0068363, which are incorporated herein by reference.

Functionally, it is believed that the zirconates act as a curing catalyst, in the presence of moisture, including atmospheric moisture, for the phenyl-containing silicones. It is also believed that they act as dispersants for the inorganic particulates, and as a flow aid, plasticizer, and dispersant for the molding material compositions.

### Titanates

As indicated above, the composition of one or more embodiments of the invention may include a titanate. In one or more embodiments, titanates include organometallic complexes of titanium. These compounds may include, for example, titanium complexed by one or more organic compounds containing functional groups attached to a hydrocarbon linkage. The organic compounds may contain one or more, and in one embodiment, two or more functional groups. The functional groups may include one or more of a carbonyl group (═O), a thio substituent (═S), alkoxy substituent (--OR), thioalkyl (--SR,) amino (--NR₂), —NO₂, (=NOR), (=NSR) and/or (-N=NR), wherein R is hydrogen or a hydrocarbon group (e.g., alkyl or alkenyl) of 1 to about 10 carbon atoms. In one or more embodiments, the titanates may include alkoxy titanates and coordinate titanates.

Useful titanates are commercially available. For example, useful alkoxy titanates are available under the tradenames LICA 12, which is neoalkoxy titanate, or KR-PRO or KR 55, which is a coordinate titanate, from Kenrich Petrochemicals, Inc., Bayonne, N.J. Other suitable titanates are available from Dorf Zetal under the tradename TYZOR TnBt, which is an alkoxytitanate.

In one or more embodiments, tetramethyiguanidine (TMG) can be used with the titanates at a dosage of 0.005% to 2% by the total weight of the silicone resins in the subject compositions as a curing synergist or accelerator.

Useful titanates are generally known as described in U.S. Publication Nos. 2017/0260354, 2016/0115299, 2015/0225530, 2013/0005876, 2009/0258977, and 2009/0068363, which are incorporated herein by reference.

Functionally, it is believed that the titanates act as a curing catalyst, in the presence of moisture, including atmospheric moisture, for the phenyl-containing silicones. It is also believed that they act as dispersants for the inorganic particulates, and as a flow aid, plasticizer, and dispersant for the molding material compositions.

### Inorganic Particulates

As indicated above, the composition of one or more embodiments of the invention may include an inorganic particulate.

In one or more embodiments, the inorganic particulates may include nanomaterials or microparticles. In these or other embodiments, the inorganic particulates may be transparent particulates and/or as high-temperature resistant particulates.

Exemplary inorganic particulates include, but are not limited to, aluminum oxide, fused aluminum dioxide, aluminum oxyhydroxide, calcined alumina oxide, gamma aluminum oxide, delta alumina oxide, delta-theta alumina oxide, alpha alumina oxide, silicon dioxide, silicon, cerium oxide, titanium dioxide, zirconium oxide, or a mixture of two or more thereof.

In one or more embodiments, the average particle size of the inorganic particulates may be up to 700 nanometers (nm), or in other embodiments up to 100 nm. In these or other embodiments, the average particle size may be in the range from about 1 to about 100 nm, in other embodiments from about 1 to about 75 nm, in other embodiments from about 1 to about 50 nm, in other embodiments from about 3 to about 50 nm, in other embodiments from about 5 to about 50 nm, in other embodiments from about 5 to about 40 nm, in other embodiments from about 5 to about 30 nm, in other embodiments from about 5 to about 20 nm, and in other embodiments from about 1 to about 15 nm. In one or more embodiments, aggregates of the inorganic particulates may have a median aggregated particle size up to 700 nm.

In one or more embodiments, the inorganic particulates can have any suitable particle size (e.g., largest dimension of the particle), such as about 1 nm to less than about 700 nm, about 5 nm to about 500 nm, about 10 nm to about 200 nm, or about 1 nm or less, or less than, equal to, or greater than about 2, 3, 4, 5, 6, 8, 10, 12, 14, 16, 18, 20, 25, 30, 35, 40, 45, 50, 55, 60, 65, 70, 75, 80, 85, 90, 95, 100, 102, 104, 106, 108, 110, 112, 114, 116, 118, 120, 122, 124, 126, 128, 130, 132, 134, 136, 138, 140, 142, 144, 146, 148, 150, 152, 154, 156, 158, 160, 165, 170, 175, 180, 185, 190, 195, 200, 210, 220, 230, 240, 250, 275, 300, 325, 350, 375, 400, 450, 500, 550, 600 nm, or less than about 700 nm. The particle size can be measured in any suitable way, such as via transmission electron microscopy (TEM). In some embodiments, the nanoparticles have one average particle sizes. In some embodiments, the inorganic particulates are distributed across multiple particle sizes such that the nanoparticles have more than one average particle size, such as at least two average particle sizes. For example, a first average particle size can be about 1 nm to less than about 700 nm, about 5 nm to about 500 nm, about 10 nm to about 200 nm, or about 1 nm or less, or less than, equal to, or greater than about 2, 3, 4, 5, 10, 20, 30, 40, 50, 75, 100, 125, 150, 175, 200, 225, 250, 275, 300, 350, 400, 450, 500, 600 nm, or less than about 700 nm, and a second average particle size can be about 1 nm to less than about 700 nm, about 5 nm to about 500 nm, about 10 nm to about 200 nm, or about 1 nm or less, or less than, equal to, or greater than about 2, 3, 4, 5, 10, 20, 30, 40, 50, 75, 100, 125, 150, 175, 200, 225, 250, 275, 300, 350, 400, 450, 500, 600 nm, or less than about 1000 nm.

In one or more embodiments, the inorganic particulates may have a refractive index in the range from about 1.4 to about 3, in other embodiments from about 1.4 to about 2.5, in other embodiments from about 1.4 to about 2, in other embodiments from about 1.4 to about 1.8, and in other embodiments from about 1.5 to about 1.68.

In one or more embodiments, the inorganic particulates may have a relatively high zeta potential. For example, the inorganic particles may have a zeta potential of at least about +30 mV or more negative than -30 mV, and in one embodiment at least about +35 mV or more negative than -35 mV.

In one or more embodiments, the inorganic particulates may be thermally stable at temperatures up to about 350° C., in other embodiments up to about 400° C., in other embodiments up to about 600° C., in other embodiments up to about 800° C., and in other embodiments up to about 1000° C. or higher.

Useful inorganic particulates are commercially available. For example, useful inorganic particulate can be obtained under the tradename Aluminum Oxide C and/or Aeroxide Alu US from Degussa Corporation, and the tradename Puralox K-160 from SASOL Corporation. ALU C, which is believed to have a mean diameter size of about 15 nanometers and an aggregated or clustered sizes of up to 700 nm, measured by Transmission Electron Microscope (TEM), a surface area of about 85-115 m squared/g, a pH value of 4.5 -5.3 in 4% dispersion, and a sieve residue (by Mocker 45 um) of , or = to 0.050, and a loss on drying of < or = to 5.0 , for 2 hours at 105° C., and a thermal conductivity greater than the amorphous thermoplastics used in the inventive molding material compositions.

Other specific examples of useful inorganic particulate include, but are not limited to, silica, fused silica, amorphous silica, metal oxides, minerals, extenders, such as aluminum oxide, hollow glass spheres, organic polymer solids, and quantum dots. A complete list of suitable inorganic particulates can be found in the Handbook of Fillers, Extenders, and Diluents, Michael and Irene Ash, Synapse Information resources, 2007, which is incorporated herein by reference. An additional listing of appropriate inorganic particulates, along with a listing of related thermal conductivity properties and refractive index values, can be found in the publication Fillers & Filled Plastics, Kirk-Othmer Encyclopedia of Chemical Technology.

In one or more embodiments, the inorganic particulates may be silane treated. As those skilled in the art appreciate, silane treatments can be performed to enhance dispersion of the inorganic particulates into the polymer(s) and/or couple the inorganic particulates to the polymer resin system. Examples of silanes that may be used include, but are not limited to, Dynasylan OCTEO (octyltriethoxsilane), Dynasylan DAMO (N-2-aminoethyl-3-aminopropyltrimethoxysilane) and Dynasylan 9165 (phenyltrimethoxysilane). Blends of Dynasylan DAMO and Dynasylan 9165 may be used. These may be thermally stable at temperatures up to about 420° C. or higher and are available from Degussa Corporation.

Useful inorganic particulates are generally known as described in U.S. Publication Nos. 2017/0260354, 2016/0115299, 2015/0225530, 2013/0005876, 2009/0258977, 2009/0068363, 2014/0243452, and 2016/0289426, which ae incorporated herein by reference.

In one or more embodiments, the inorganic particulates may be surface treated with one or more titanates, one or more zirconates, or a mixture thereof. The titanates and zirconates include those described herein.

### Silsesquioxanes

As indicated above, the composition of one or more embodiments of the invention may include a silsesquioxanes.

In one or more embodiments, the silsesquioxane or polyhedral oligomeric silsesquioxane, when in particulate form, may be employed within the molding material compositions as the particulate component.

In one or more embodiments, silsesquioxanes, which may also be referred to as polysilsesquioxanes or oligomeric silsesquioxanes, are materials represented by the formula [RSiO_{1.5}] ∞ where ∞ represents molar degree of polymerization and R is a monovalent organic group. In one or more embodiments, the monovalent organic group may include a hydrocarbyl group, a hydrocarbyloxy group, and a siloxy group. The nature and scope of silsesquioxanes are well known in the art as evidenced by U.S. Pat. Nos. 7,723,415, 6,911,518, 6,927,270, 6,933,345, 6,972,312, 7,485,692, 7,638,195, 7,723,415, 7,737,228, 7,888,435, and 7,897,667, which are incorporated herein by reference.

In one or more embodiments, the hydrocarbyl groups include, but are not limited to, alkyl, cycloalkyl, substituted cycloalkyl, alkenyl, cycloalkenyl, substituted cycloalkenyl, aryl, allyl, substituted aryl, aralkyl, alkaryl, or alkynyl groups. Substituted hydrocarbyl groups include hydrocarbyl groups in which one or more hydrogen atoms have been replaced by a substituent such as an alkyl group. In one or more embodiments, the hydrocarbyl groups may include from one, or the appropriate minimum number of carbon atoms to form the group, to 20 carbon atoms. These hydrocarbyl groups may contain heteroatoms such as, but not limited to, nitrogen, boron, oxygen, silicon, sulfur, and phosphorus atoms.

In one or more embodiments, the hydrocarbyloxy groups include, but are not limited to, alkoxy, cycloalkoxy, substituted cycloalkoxy, alkenyloxy, cycloalkenyloxy, substituted cycloalkenyloxy, aryloxy, allyloxy, substituted aryloxy, aralkyloxy, alkaryloxy, or alkynyloxy groups. Substituted hydrocarbyloxy groups include hydrocarbyloxy groups in which one or more hydrogen atoms attached to a carbon atom have been replaced by a substituent such as an alkyl group. In one or more embodiments, the hydrocarbyloxy groups may include from one, or the appropriate minimum number of carbon atoms to form the group, to 20 carbon atoms. The hydrocarbyloxy groups may contain heteroatoms such as, but not limited to nitrogen, boron, oxygen, silicon, sulfur, and phosphorus atoms.

The monovalent organic groups (e.g. the hydrocarbyl and hydrocarbyloxy groups) may include heteroatoms such as, but not limited to, oxygen, nitrogen, silicon, sulfur, phosphorus, chlorine, bromine, and fluorine. The heteroatoms may form functionalities such as hydroxyl groups and/or carbonyl groups, which may form ester groups, alcohol groups, acid groups, and ketone groups and acyl groups. Other functionalities include, but are not limited to, amines, ethers, and epoxides.

Silsesquioxanes may be either homoleptic or heteroleptic. Homoleptic systems contain only one type of R group while heteroleptic systems contain more than one type of R group. As a special case R may also include fluorinated organic groups. In one or more embodiments, the silsesquioxanes may be defined by the formula [(RSiO_{1.5})ₙ]_{Σ#} for homoleptic compositions, [(RSiO_{1.5})ₙ(R′SiO_{1.5})ₘ]_{Σ#} for heteroleptic compositions (where R≠R′), [(RSiO_{1.5})ₙ(RXSiO_{1.0})ₘ]_{Σ#} for functionalized heteroleptic compositions (where R groups can be equivalent or inequivalent), and [(RSiO_{1.5})ₙ (RSiO_{1.0})ₘ (M)ⱼ]_{Σ#} for heterofunctionalized heteroleptic compositions. In all of the above R is the same as defined above and X includes but is not limited to OH, Cl, Br, I, alkoxide (OR), acetate (OOCR), peroxide (OOR), amine (NR₂), isocyanate (NCO), and R. The symbol M refers to metallic elements within the composition that include high and low Z metals including s and p block metals, d and f block transition, lanthanide, actinide metals, in particular, Al, B, Ga, Gd, Ce, W, Ni, Eu, U, Y, Zn, Mn, Os, Ir, Ta, Cd, Cu, Ag, V, As, Tb, In, Ba, Ti, Sm, Sr, Pt, Pb, Lu, Cs, Tl, and Te. The symbols m, n and j refer to the stoichiometry of the composition. The symbol Σ indicates that the composition forms a nanostructure and the symbol # refers to the number of silicon atoms contained within the nanostructure. The value for # is usually the sum of m+n, where n ranges typically from 1 to 24 and m ranges typically from 1 to 12. It should be noted that Σ# is not to be confused as a multiplier for determining stoichiometry, as it merely describes the overall nanostructural characteristics of the system (aka cage size).

In one or more embodiments, silsesquioxanes include polyhedral silsesquioxanes, ladder-structured silsesquioxanes, and fully random silsesquioxanes. The polyhedral silsesquioxanes include caged and partial caged structures, the latter of which lacks a complete connection of all units in the cage.

In one or more embodiments, the silsesquioxanes employed in practice of the present invention include one or more hydrophobic substituents and one or more hydrophilic substituents.

In one or more embodiments, the silsesquioxanes are partial caged structures that may be defined by the formula

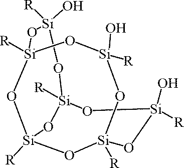

where each R is independently a monovalent organic group. These partial caged structures of these embodiments may be referred to as silanols. In particular embodiments, each R is a phenyl group. In other embodiments, each R is a branched alkyl group such as an isooctyl group.

In one or more embodiments, useful silsesquioxanes include 1,3,5,7,9,11,14-heptahydrocarbyltricyclo[7.3.3.1(5,110]heptasiloxane-endo- -3,7,14-triols such as, but not limited to, 1,3,5,7,9,11,14-heptaphenyltricyclo[7.3.3.1(5,110]heptasiloxane-endo-3,7,- 14-triol, 1,3,5,7,9,11,14-heptaisobutyltricyclo[7.3.3.1(5,110]heptasiloxan- e-endo-3,7,14-triol, 1,3,5,7,9,11,14-heptaisooctyltricyclo[7.3.3.1(5,110]heptasiloxane-endo-3,-7,14-triol, 1,3,5,7,9,11,14-heptaethyltricyclo[7.3.3.1(5,110]heptasiloxane-endo-3,7,1- 4-triol, 1,3,5,7,9,11,14-heptacyclopentyltricyclo [7.3.3.1(5,110]heptasilox- ane-endo-3,7,14-triol, and 1,3,5,7,9,11,14-heptacyclohexyltricyclo [7.3.3.1(5,110]heptasiloxane-endo-- 3,7,14-triol.

Useful polyhedral silsesquioxanes include those available under the tradenames Polyhedral Oligomeric Silsesquioxane (POSS), Polyhedral Oligometallosesquioxane (POMS), and Polyhedral Oligomeric Silicate (POS) (Hybrid Plastics). Other commercial sources include those available under the tradenames Janus Cubes, Phenyls, and T-Cages (Mayaterials). Specific examples of useful silsesquioxanes include those available under the tradenames SO1400(trisilanolcyclohexyl POSS), SO1430 (trisilanolcyclopentyl POSS), SO1440 (disilanolisobutyl POSS), SO1444 (trisilanolethyl POSS), SO1450 (trisilanolisobutyl POSS), SO1455 (trisilanolisooctyl POSS), SO1457 (trisilanolphenyl POSS lithium salt), SO1458 (trisilanolphenyl POSS), and SO1460 (tetrasilanolphenyl POSS). POSS can be obtained from Hybrid Plastics.

Useful silsesquioxanes are generally known as described in U.S. Publication Nos. 2009/0258977, 2013/0005876, 2014/0243452, 2016/0115299, and 2016/0289426, which ae incorporated herein by reference.

### Biphenols

As indicated above, the composition of one or more embodiments of the invention may include a biphenol. An exemplary biphenol includes 4,4′-biphenol, which is commercially available from Schenectady International, Schenectady, N.Y.

Useful biphenols are generally known as described in U.S. Publication Nos. 2017/0260354, 2016/0115299, 2015/0225530, 2013/0005876, 2009/0258977, 2009/0068363, 2014/0243452, and 2016/0289426, which are incorporated herein by reference.

Functionally, it is believed that the biphenol may combine with other constituents, such as the silicone and/or thermoplastic resin to increase the Tg of the inventive molding composition.

### Cycloaliphatic Epoxy Resins

As indicated above, the composition of one or more embodiments of the invention may include a cycloaliphatic epoxy resin. Useful cycloaliphatic epoxide resins for use in this invention are commercially available such as those sold under the tradename S-06E Synasia, or ERL4221, ERL4221D, UVR 6105, and alternatively or in combination with any of UVR 6110.

Useful cycloaliphatic epoxy resins are generally known as described in U.S. Pat. No. 5,905,104, which is incorporated herein by reference.

Functionally, it is believed that the cycloaliphatic epoxy resins can be used as a stabilizer and or synergist for coupling the silicone component with the thermoplastic resin.

### Additional Constituents

Additionally, the molding compositions can contain dispersants, plasticizers, primary and secondary antioxidants, or mixtures of any two or more such antioxidants or stabilizers including phosphorous containing stabilizers, phosphonites, and, or hindered or half-hindered phenol stabilizers, including Doverphos 9228 and 9228PC, Mayzo 168, Mayzo Co, Clariant, Ethanox 330, PEPQ, Clariant, other thermal stabilizers such as ERL 4221 cationic epoxy, Union Carbide; alcohols, acids, halogenated or non-halogenated fire retardants, or mixtures of the two; fire retardant synergists, anti-dripping agents, antistatic agents, silsesquioxanes, as long as such additional additions are miscible within the thermoplastic composition and do not deleteriously effect the intended performance and properties of the inventive composite thermoplastic molding compositions. Preferably the additives should be selected by thermal stability in order to withstand the given processing temperature of a particular composite thermoplastic molding composition of this invention.

Additionally, the inventive thermoplastic composition can contain other particulate including any organic or inorganic pigment, or combination thereof. Examples include, but are not limited to, titanium dioxide (TiO2), TiO2 opacifiers and extenders, such as calcium carbonate, clay, opaque polymers and pre-composite polymers, such as Ropaque.TM. and Evoque.TM. (Dow Corning Materials), yellow, blue, carbon black, metallic, conductive, luminescent, fluorescent, phosphorus, and quantum dots pigments. An extensive list of suitable pigments and guidelines for use can be found in the European Coatings Handbook, Thomas Brock, Michael Groteklaes, Peter Mischke, Vincentz NeAeroxide.

### Constituent Amounts

The thermoplastic resin may be referred to as the “host thermoplastic” because it provides by absolute volume the largest component of the inventive molding material compositions.

### Thermoplastic

In one or more embodiments, the molding compositions of the present invention include greater than 70, in other embodiments greater than 85, and in other embodiments greater than 99.9 wt % of the thermoplastic resin based upon the entire weight of the molding composition. In these or other embodiments, the molding compositions of the present invention include less than 100 wt %, in other embodiments less than 99.996 wt %, and in other embodiments less than 99.9 wt % of the thermoplastic resin based upon the entire weight of the molding composition. In one or more embodiments, the molding compositions of the present invention include from about 70 to about 99.995 wt %, in other embodiments from about 80 to about 99.9 wt %, and in other embodiments from about 90 to about 99 wt % of the thermoplastic based upon the entire weight of the molding composition.

### Phenyl-Containing Silicone

In one or more embodiments, the molding compositions of the present invention include greater than 0.005 parts by weight (pbw), in other embodiments greater than 1.0 pbw, in other embodiments greater than 10 pbw, in other embodiments at least 0.005 pbw, in other embodiments at least 0.01 pbw, in other embodiments at least 0.1 pbw, and in other embodiments at least 1.0 pbw phenyl-containing silicone per 100 parts by weight of the thermoplastic resin (php). In these or other embodiments, the molding compositions of the present invention include less than 0.1 pbw, in other embodiments less than 5 pbw, and in other embodiments less than 10 pbw phenyl-containing silicone per 100 parts by weight of the thermoplastic resin (php). In one or more embodiments, the molding compositions of the present invention includes from about 0.005 to about 10 pbw, in other embodiments from about 0.005 to about 0.05 pbw, in other embodiments from about 0.1 to about 5 pbw, and in other embodiments from about 5 to about 10 pbw phenyl-containing silicone per 100 parts by weight of the thermoplastic resin (php).

### Zirconate

In one or more embodiments, the molding compositions of the present invention include greater than 0.005 parts by weight (pbw), in other embodiments greater than 0.05 pbw, in other embodiments greater than 0.01 pbw, in other embodiments at least 0.005 pbw, in other embodiments at least 0.01 pbw, in other embodiments at least 0.02 pbw, and in other embodiments at least 0.5 parts by weight (pbw) zirconate per 100 parts by weight of the thermoplastic resin (php). In these or other embodiments, the molding compositions of the present invention include less than 0.01 pbw, in other embodiments less than 0.05 pbw, and in other embodiments less than 0.5 pbw zirconate per 100 parts by weight of the thermoplastic resin (php). In one or more embodiments, the molding compositions of the present invention includes from about 0.005 to about 1.0 pbw, in other embodiments from about 0.01 to about 0.5 pbw, and in other embodiments from about 0.02 to about 1.0 pbw zirconate per 100 parts by weight of the thermoplastic resin (php).

### Titanate

In one or more embodiments, the molding compositions of the present invention include greater than 0.005 parts by weight, in other embodiments greater than 0.01 pbw, in other embodiments greater than 0.02 pbw, in other embodiments at least 0.03 pbw, in other embodiments at least 0.1 pbw, in other embodiments at least 0.3 pbw, and in other embodiments at least 0.5 parts by weight (pbw) titanate per 100 parts by weight of the thermoplastic resin (php). In these or other embodiments, the molding compositions of the present invention include less than 0.01 pbw, in other embodiments less than 0.05 pbw, and in other embodiments less than 0.5 pbw titanate per 100 parts by weight of the thermoplastic resin (php). In one or more embodiments, the molding compositions of the present invention includes from about 0.005 to about 1.0 pbw, in other embodiments from about 0.01 to about 0.5 pbw, and in other embodiments from about 0.02 to about 1.0 pbw titanate per 100 parts by weight of the thermoplastic resin (php) .

### Inorganic Particulate

In one or more embodiments, the molding compositions of the present invention include greater than 0.01 parts by weight (pbw), in other embodiments greater than 0.05 pbw, in other embodiments greater than 25 pbw, in other embodiments at least 0.01 pbw, in other embodiments at least 0.05 pbw, in other embodiments at least 1.0 pbw, and in other embodiments at least 20 parts by weight (pbw) inorganic particulate per 100 parts by weight of the thermoplastic resin (php). In these or other embodiments, the molding compositions of the present invention include less than 0.02 pbw, in other embodiments less than 0.1 pbw, and in other embodiments less than 30 pbw inorganic particulate per 100 parts by weight of the thermoplastic resin (php). In one or more embodiments, the molding compositions of the present invention includes from about 0.01 to about 30 pbw, in other embodiments from about 0.05 to about 20 pbw, and in other embodiments from about 0.1 to about 10 pbw inorganic particulate per 100 parts by weight of the thermoplastic resin (php).

### Silsesquioxane

In one or more embodiments, the molding compositions of the present invention include greater than 0.001 parts by weight (pbw), in other embodiments greater than 0.1 pbw, in other embodiments greater than 0.5 pbw, in other embodiments at least 0.001 pbw, in other embodiments at least 0.1 pbw, in other embodiments at least 0.5 pbw, and in other embodiments at least 5 parts by weight (pbw) silsesquioxane per 100 parts by weight of the thermoplastic resin (php). In these or other embodiments, the molding compositions of the present invention include less than 6.0 pbw, in other embodiments less than 1.0 pbw, and in other embodiments less than 0.01 pbw silsesquioxane per 100 parts by weight of the thermoplastic resin (php). In one or more embodiments, the molding compositions of the present invention includes from about 0.001 to about 6.0 pbw, in other embodiments from about 0.01 to about 3.0 pbw, and in other embodiments from about 0.1 to about 6.0 pbw silsesquioxane per 100 parts by weight of the thermoplastic resin (php).

### Biphenol

In one or more embodiments, the molding compositions of the present invention include greater than 0.001 parts by weight (pbw), in other embodiments greater than 0.9 pbw, in other embodiments greater than 0.01 pbw, in other embodiments at least 0.1 pbw, in other embodiments at least 0.005 pbw, in other embodiments at least 0.01 pbw, and in other embodiments at least 0.05 parts by weight (pbw) biphenol per 100 parts by weight of the thermoplastic resin (php). In these or other embodiments, the molding compositions of the present invention include less than 0.01 pbw, in other embodiments less than 0.05 pbw, and in other embodiments less than1.0 pbw biphenol per 100 parts by weight of the thermoplastic resin (php). In one or more embodiments, the molding compositions of the present invention includes from about 0.001 to about 1.0 pbw, in other embodiments from about 0.01 to about 0.5 pbw, and in other embodiments from about 0.02 to about 0.05 pbw biphenol per 0.1 parts by weight of the thermoplastic resin (php) .

### Cycloaliphatic Epoxide

In one or more embodiments, the molding compositions of the present invention include greater than 0.001 parts by weight (pbw), in other embodiments greater than 0.01 pbw, in other embodiments greater than 0.05 pbw, in other embodiments at least 0.1 pbw, in other embodiments at least 0.001 pbw, in other embodiments at least 0.01 pbw, and in other embodiments at least 0.1 parts by weight (pbw) cycloaliphatic epoxide per 100 parts by weight of the thermoplastic resin (php). In these or other embodiments, the molding compositions of the present invention include less than 0.01 pbw, in other embodiments less than 0.05 pbw, and in other embodiments less than 1.0 pbw cycloaliphatic epoxide per 100 parts by weight of the thermoplastic resin (php). In one or more embodiments, the molding compositions of the present invention includes from about 0.001 to about 1.0 pbw, in other embodiments from about 0.01 to about 0.5 pbw, and in other embodiments from about 0.02 to about 0.2 pbw cycloaliphatic epoxide per 100 parts by weight of the thermoplastic resin (php).

### Characteristics of Molding Composition

In one or more embodiments, the molding compositions of the present invention have an increased glass transition temperature (Tg) relative to the Tg of the thermoplastic resin (i.e. the thermoplastic resin in the absence of the silicone or other additives). In one or more embodiments, the Tg of the molding compositions of this invention is at least 1 %, in other embodiments at least 2%, in other embodiments at least 5%, in other embodiments at least 10%, in other embodiments at least 15%, and in other embodiments at least 20% higher than the Tg of the thermoplastic resin employed in the composition. In these or other embodiments, the Tg of the molding compositions of this invention is greater than 200° C., in another embodiments, greater than 250° C., and in another embodiments, greater than 300° C.

In one or more embodiments, the molding compositions of the present invention have a decreased (or reduced) coefficient of thermal expansion (CTE) or coefficient of linear thermal expansion (CTLE), relative to the CTE or CTLE of the thermoplastic resin (i.e. the thermoplastic resin in the absence of the silicone or other additives). In one or more embodiments, the CTE or CTLE of the molding compositions of this invention is at least 5%, in other embodiments at least 10%, in other embodiments at least 15%, in other embodiments at least 20%, in other embodiments at least 25%, and in other embodiments at least 50% lower than the CTE or CTLE of the thermoplastic resin employed in the composition. Unless otherwise reported, CTE is determined according to ASTM D696-2016, ASTM E831-2014, and ASTM E1545-2016.

As described above, the molding compositions of the present invention are prepared by melt processing the various constituents of the blend. Given the volumes of the various constituents, it will be appreciated that the thermoplastic resin forms the continuous phase of the composition (i.e. is the matrix) and the other constituents, such as the silicone, as well as the various other additives, are dispersed therein. In one or more embodiments, the silicone and/or the other additives are phase separated from the thermoplastic resin. In these or other embodiments, the silicone and/or the other additives are co-continuous with the thermoplastic resin. In these or other embodiments, the silicone and/or the other additives are dissolved in the thermoplastic resin.

### Specific Embodiments

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

In one or more embodiments, the molding material comprising (a) at least 70% by total weight of the composition of one or a mixture of one or more thermoplastic polymers or mixtures of thermoplastic polymers or one or more thermoplastic co-polymers; and (b) one or more phenyl silicone resins, or one or more phenyl methyl silicone resins, or a mixture of one or more phenyl silicone resins and one or more phenyl methyl silicone resins, or in combination with other organic or inorganic, or organic -inorganic materials, in an amount of between 0.0005% to 30% by total weight of the composition. The other materials and chemicals include inorganic particulates, clusters or aggregated inorganic particulates, thermally conductive inorganic particulates with OH and Si—O—H or C—O—H functionality, inorganic particulates with surface hydrophobic treatments and surface coupling agents, dispersing agents, stabilizers, antioxidants, and chemical and light compatibilizers.

In one embodiment, the inventive composite molding material comprises (A) 70% to 99.995% by weight, in particular from 90.0% to 99.995% by weight of the total weight of the composition at least one thermoplastic polymer, or copolymer thermoplastics, or a mixture of thermoplastic polymers or a mixture of thermoplastic co-polymers having a glass transition temperature of greater than 80° C. and, preferably, greater than 130° C.; and (B) from 0.005% to 10% by weight, in particular from 0.01% to 5.0% by weight of the total weight of the composition at least of a one or more phenyl silicone resins, or one or more phenyl methyl silicone resins, or a mixture of one or more phenyl silicone resins and one or more phenyl methyl silicone resins.

In one embodiment, the inventive composite molding material comprises (A) 70% to 99.995% by weight, in particular from 90.0% to 99.995% by weight of the total weight of the composition at least one thermoplastic polymer, or copolymer thermoplastics, or a mixture of thermoplastic polymers or a mixture of thermoplastic co-polymers having a glass transition temperature of greater than 80° C. and, preferably, greater than 130° C.; and (B) from 0.005% to 10% by weight, in particular from 0.01% to 5.0% by weight of the total weight of the composition at least of a one or more phenyl silicone resins, or one or more phenyl methyl silicone resins, or a mixture of one or more phenyl silicone resins and one or more phenyl methyl silicone resins; and (C) 0.001% to 1.0% by weight of the total weight of the composition at least one zirconate, or one titanate, or a mixture of one or more zirconates and one or more titanates.

In one embodiment, the inventive molding material comprises (A) 70% to 99.995% by weight, in particular from 90.0% to 99.995% by weight of the total weight of the composition at least one thermoplastic polymer, or copolymer thermoplastics, or a mixture of thermoplastic polymers or a mixture of thermoplastic co-polymers having a glass transition temperature of greater than 130° C.; and (B) from 0.005% to 10% by weight, in particular from 0.01% to 5.0% by weight of the total weight of the composition at least of a one or more phenyl silicone resins, or one or more phenyl methyl silicone resins, or a mixture of one or more phenyl silicone resins and one or more phenyl methyl silicone resins; (D) and 0.01% to 30% by weight, preferably .03% to 15% by weight of the total weight of the composition of inorganic particulates having an average particle size in the range up to 500 nanometers or aggregates of inorganic particulates having a median aggregated particle size up to 700 nanometers, and an index of refraction in the range from 1.4 to 2.6.

In one embodiment, the inventive molding material comprises (A) 70% to 99.995% by weight, in particular from 90.0% to 99.995% by weight of the total weight of the composition at least one thermoplastic polymer, or copolymer thermoplastics, or a mixture of thermoplastic polymers or a mixture of thermoplastic co-polymers having a glass transition temperature of greater than 130° C.; and (B) from 0.005% to 10% by weight, in particular from 0.01% to 5.0% by weight of the total weight of the composition at least of a one or more phenyl silicone resins, or one or more phenyl methyl silicone resins, or a mixture of one or more phenyl silicone resins and one or more phenyl methyl silicone resins; and (E) 0.001% to 6% by weight of the total weight of the composition at least one biphenol, or one polyhedral oligomeric silsesquioxane or a mixture of one or more thereof.

In one embodiment, the inventive molding material comprises (A) 70% to 99.995% by weight, in particular from 90.0% to 99.995% by weight of the total weight of the composition at least one thermoplastic polymer, or copolymer thermoplastics, or a mixture of thermoplastic polymers or a mixture of thermoplastic co-polymers having a glass transition temperature of greater than 80° C. and, preferably, greater than 130° C.; and (B) from 0.005% to 10% by weight, in particular from 0.01% to 5.0% by weight of the total weight of the composition at least of a one or more phenyl silicone resins, or one or more phenyl methyl silicone resins, or a mixture of one or more phenyl silicone resins and one or more phenyl methyl silicone resins; and (F) 0.001% to 0.5% by weight of the total weight of the composition at least one cycloaliphatic epoxy resin.

In one embodiment, the inventive molding material comprises (A) 70% to 99.995%, in particular from 90.0% to 99.995% by weight of the total weight of the composition at least one thermoplastic polymer, or copolymer thermoplastics, or a mixture of thermoplastic polymers or a mixture of thermoplastic co-polymers having a glass transition temperature of greater than 80° C. and, preferably, greater than 130° C.; and (B) from 0.005% to 10% by weight, in particular from 0.01% to 5.0% by weight of the total weight of the composition at least of a one or more phenyl silicone resins, or one or more phenyl methyl silicone resins, or a mixture of one or more phenyl silicone resins and one or more phenyl methyl silicone resins; and (C) 0.001% to 1.0% by weight of the total weight of the compositions at least one zirconate, or one titanate, or a mixture of one or more zirconates and one or more titanates, and (D) 0.01% to 30% by weight, preferably .03% to 15% by weight of the total weight of the composition inorganic particulates having an average particle size in the range up to 500 nanometers or aggregates of inorganic particulates having a median aggregated particle size up to 700 nanometers, and an index of refraction in the range from 1.4 to 2.6; and, (E) 0.001% to 6% by weight of the total weight of the composition at least one biphenol, or one polyhedral oligomeric silsesquioxane or a mixture of one or more thereof; with proviso that with the proviso that when the polyhedral oligomeric silsesquioxane is in the form of particulates with an average particle size up to about 100 nanometers, the polyhedral oligomeric silsesquioxane particulates are optionally used both as component (E) and as a partial or complete replacement for component (D); and (F ) 0.001% to 0.3% by weight of the total weight of the composition at least one cycloaliphatic epoxy resin.

In one embodiment, the inventive molding material comprises (A) 70% to 99.995%, in particular from 90.0% to 99.995% by weight of the total weight of the composition at least one thermoplastic polymer, or copolymer thermoplastics, or a mixture of thermoplastic polymers or a mixture of thermoplastic co-polymers having a glass transition temperature of greater than 80° C. and, preferably, greater than 130° C.; and (B) from 0.005% to 10% by weight, in particular from 0.01% to 5.0% by weight of the total weight of the composition at least of a one or more phenyl silicone resins, or one or more phenyl methyl silicone resins, or a mixture of one or more phenyl silicone resins and one or more phenyl methyl silicone resins; and any mixture of one or more of (C) 0.001% to 1.0% by weight of the total weight of the compositions at least one zirconate, or one titanate, or a mixture of one or more zirconates and one or more titanates; (D) 0.01% to 30% by weight, preferably 0.03% to 15% by weight of the total weight of the composition inorganic particulates having an average particle size in the range up to 500 nanometers or aggregates of inorganic particulates having a median aggregated particle size up to 700 nanometers, and an index of refraction in the range from 1.4 to 2.6; (E) 0.001% to 6% by weight of the total weight of the composition at least one biphenol, or one polyhedral oligomeric silsesquioxane or a mixture of one or more thereof; with proviso that with the proviso that when the polyhedral oligomeric silsesquioxane is in the form of particulates with an average particle size up to about 100 nanometers, the polyhedral oligomeric silsesquioxane particulates are optionally used both as component (E) and as a partial or complete replacement for component (D); (F) 0.001% to 0.3% by weight of the total weight of the composition at least one cycloaliphatic epoxy resin.

In various embodiments, the invention relates to an additive composition comprising Component (B); and any mixture of two or more of Component (C); or Component (D); or Component (E); or Component (F) with the proviso that the dosage of each Component is equal to or less than the maximum dosage of each Component specified herein, calculated as a % of the total weight of the Component of the total weight of the composite thermoplastic molding material composition.

The invention relates to a polymer composition, comprising (A) at least one thermoplastic polymer, or copolymer thermoplastics, or a mixture of thermoplastic polymers or a mixture of thermoplastic co-polymers having a glass transition temperature of greater than 80° C. and, preferably, greater than 130° C.; and (B) at least of a one or more phenyl silicone resins, or one or more phenyl methyl silicone resins, or a mixture of one or more phenyl silicone resins and one or more phenyl methyl silicone resins; and any mixture of one or more of (C) an effective amount of least one zirconate, or one titanate, or a mixture of one or more zirconates and one or more titanates; (D) at least one or a mixture of one or more inorganic particulates having an average particle size in the range up to 700 nanometers, and an index of refraction in the range from 1.4 to 2.6; (E) at least one biphenol, or one polyhedral oligomeric silsesquioxane or a mixture of one or more thereof; with proviso that with the proviso that when the polyhedral oligomeric silsesquioxane is in the form of particulates with an average particle size up to about 100 nanometers, the polyhedral oligomeric silsesquioxane particulates are optionally used both as component (E) and as a partial or complete replacement for component (D); (F) and effective amount of at least one cycloaliphatic epoxy resin. The invention refers to methods of making the inventive polymer compositions. The polymer composition may be a high temperature organic, inorganic composite thermoplastic suitable for forming, such as by molding, transparent articles such as lenses.

Surprisingly, applicant discovered that the object of the invention is achieved by the composite molding material of this invention, the molding material comprising (a) at least 70% by total weight of the composition of one or a mixture of one or more thermoplastic polymers or mixtures of thermoplastic polymers or one or more thermoplastic co-polymers; and (b) one or more phenyl silicone resins, or one or more phenyl methyl silicone resins, or a mixture of one or more phenyl silicone resins and one or more phenyl methyl silicone resins, or in combination with other organic or inorganic, or organic - inorganic materials, in an amount of between 0.0005% to 30% by total weight of the composition. The other materials and chemicals include inorganic particulates, clusters or aggregated inorganic particulates, thermally conductive inorganic particulates with OH and Si—O—H or C—O—H functionality, inorganic particulates with surface hydrophobic treatments and surface coupling agents, dispersing agents, stabilizers, antioxidants, and chemical and light compatibilizers.

In various embodiments, the invention relates to an additive composition made by combining (Component B) from 0.005% to 10% by weight, in particular from 0.01% to 5.0% by weight of the total weight of the composition at least of a one or more phenyl silicone resins, or one or more phenyl methyl silicone resins, or a mixture of one or more phenyl silicone resins and one or more phenyl methyl silicone resins; and any mixture of one or more of (Component C) 0.001% to 1.0% by weight of the total weight of the compositions at least one zirconate, or one titanate, or a mixture of one or more zirconates and one or more titanates; (Component D) 0.01% to 30% by weight, preferably 0.03% to 15% by weight of the total weight of the composition inorganic particulates having an average particle size in the range up to 500 nanometers or aggregates of inorganic particulates having a median aggregated particle size up to 700 nanometers, and an index of refraction in the range from 1.4 to 2.6; (Component E) 0.001% to 6% by weight of the total weight of the composition at least one biphenol, or one polyhedral oligomeric silsesquioxane or a mixture of one or more thereof; with proviso that with the proviso that when the polyhedral oligomeric silsesquioxane is in the form of particulates with an average particle size up to about 100 nanometers, the polyhedral oligomeric silsesquioxane particulates are optionally used both as Component (E) and as a partial or complete replacement for component (D); (Component F) 0.001% to 0.3% by weight of the total weight of the composition at least one cycloaliphatic epoxy resin.

In various embodiments, the invention relates to an additive composition comprising Component B, 90%% to 99.995% of the total weight of the additive composition of one or more phenyl silicone resins, or one or more phenyl methyl silicone resins, or a mixture of one or more phenyl silicone resins and one or more phenyl methyl silicone resins; and Component C, 0.005% to 10% by weight of the total weight of the additive composition at least one zirconate, or one titanate, or a mixture of one or more zirconates and one or more titanates.

In various embodiments, the invention relates to an additive composition comprising Component B, 30% to 70% of the total weight of the additive composition of one or more phenyl silicone resins, or one or more phenyl methyl silicone resins, or a mixture of one or more phenyl silicone resins and one or more phenyl methyl silicone resins; and Component D, 30 to 70% by weight of the total weight of the additive composition of inorganic particulates having an average particle size in the range up to 500 nanometers or aggregates of inorganic particulates having a median aggregated particle size up to 700 nanometers.

In various embodiments, the invention relates to an additive composition comprising Component B, 10% to 70% of the total weight of the additive composition of one or more phenyl silicone resins and one or more phenyl methyl silicone resins, or one or more phenyl methyl silicone resins, or a mixture of one or more phenyl silicone resins and one or more phenyl methyl silicone resins; and Component E, 10% to 70% by weight of the total weight of the additive composition at least one biphenol, or one polyhedral oligomeric silsesquioxane or a mixture of one or more thereof.

In various embodiments, the invention relates to an additive composition comprising Component B, 50% to 99.98% of the total weight of the additive composition of one or more phenyl silicone resins and one or more phenyl methyl silicone resins, or one or more phenyl methyl silicone resins, or a mixture of one or more phenyl silicone resins and one or more phenyl methyl silicone resins; and Component F, 0.02% to 50% by weight of the total weight of the additive composition at least one cycloaliphatic epoxy resin.

### Method for Forming Molding Composition

The molding compositions of this invention may be made by blending all of the additive components together as a dry powder or as a loosely agglomerated free flowing powder, or by first melting mixing the additives together by kneading or extrusion, letting the mixture cool and harden, then grinding into a free flowing powder or cutting into pellets. The molding compositions of this invention may be made by either melting, often referred to as extrusion or compounding, of all of the components at temperatures greater than the melting temperature of the host thermoplastics (e.g. amorphous thermoplastic component). Extrusion or compounding methods include masterbatching, which is a method well known to those of skill in the art. Other suitable methods of making the inventive composite thermoplastic compositions and additive compositions of this invention are set forth in U.S. Pat. Application 2009/0258977A1 Smetana; David A., Oct. 15, 2009, which is incorporated herein by reference.

Molded articles of this invention can be made by any laboratory scale or commercial scale of solvent cast molding, compression molding, 3D printing or injection compression molding, or injection molding, which are methods well known to those of skill in the art and as set forth herein and as set forth in U.S. Pat. Application 2009/0258977A1 Smetana; David A., Oct. 15, 2009, which is incorporated herein by reference.

### Industrial Applicability

In various embodiments, the present invention provides an article including a molded article made from the inventive composite molding materials.

In various embodiments, the present invention provides a molded article, such as a lens, that is transparent, having a thickness of 0.1 millimeters (mm) or greater, made from the innovative thermoplastic composition has a luminous light transmission of at least 50% at a wavelength one or more wavelengths of 450 nm, 500 nm, 600 nm, 700 nm, 750 nm, 800 nm, 850 nm, 900 nm, or 1000 nm, or at wavelengths of 450 to 1000 nanometers; or, in another embodiment, a molded article having a thickness of 0.1 millimeters (mm) or greater, made from the innovative thermoplastic composition has a luminous light transmission of at least 60% at a wavelength one or more wavelengths of, 450 nm, 500 nm, 600 nm, 700 nm, 750 nm, 800 nm, 850 nm, 900 nm, or 1000 nm, or at wavelengths of 450 to 1000 nanometers; or in another embodiment, a molded article having a thickness of 0.1 millimeters (mm) or greater, made from the innovative thermoplastic composition has a luminous light transmission of at least 70% at a wavelength one or more wavelengths of, 450 nm, 500 nm, 600 nm, 700 nm, 750 nm, 800 nm, 850 nm, 900 nm, or 1000 nm, or at wavelengths of 450 to 1000 nanometers; or in another embodiment, a molded article having a thickness of 0.1 millimeters (mm) or greater, made from the innovative thermoplastic composition has a luminous light transmission of at least 80% at a wavelength one or more wavelengths of, 450 nm, 500 nm, 600 nm, 700,nm, 750 nm, 800 nm, 850 nm, 900 nm, or 1000 nm, or at wavelengths of 450 nm to 1000 nanometers. Light transmission measurements were done in accordance with ASTM D1003, Standard Test Method for Haze and Luminous Transmittance of Transparent Plastics. In various embodiments, the present invention provides a molded article may be translucent and surfaces of the molded article may be embossed or textured.

The invention provides for an article made from the innovative composite thermoplastic molding material composition that has a Tg higher than the Tg of the host amorphous thermoplastic, Component A, of the inventive composite thermoplastic composition. The invention provides for an article made from the innovative composite thermoplastic molding material composition that has a CTE or CTLE lower than the CTE or CTLE of the host amorphous thermoplastic, Component A, of the inventive composite thermoplastic composition.

### General Definitions

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” can mean having a trivial amount of, such that a composition is about 0 wt % to about 5 wt % of the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

The term “organic group” as used herein refers to any carbon-containing functional group. Examples can include an oxygen-containing group such as an alkoxy group, aryloxy group, aralkyloxy group, oxo(carbonyl) group; a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH.sub.2C(O)R, C(S)R, C(O)OR, OC(O)R, C(O)N(R)₂, OC(O)N(R)₂, C(S)N(R)₂, (CH₂)₀-2N(R)C(O)R, (CH₂)₀-2N(R)N(R)₂, N(R)N(R)C(O)R, N(R)N(R)C(O)OR, N(R)N(R)CON(R)2, N(R)SO₂R, N(R)SO₂N(R)2, N(R)C(O)OR, N(R)C(O)R, N(R)C(S)R, N(R)C(O)N(R)₂, N(R)C(S)N(R)₂, N(COR)COR, N(OR)R, C(=NH)N(R)₂, C(O)N(OR)R, C(=NOR)R, and substituted or unsubstituted (C₁-C₁₀₀)hydrocarbyl, wherein R can be hydrogen (in examples that include other carbon atoms) or a carbon-based moiety, and wherein the carbon-based moiety can be substituted or unsubstituted.

The term “substituted” as used herein in conjunction with a molecule or an organic group as defined herein refers to the state in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as silanol groups, hydroxy groups, alkoxy groups, aryloxy groups, aralkyloxy groups, oxo(carbonyl) groups, such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀-2N(R)C(O)R, (CH₂)₀-2N(R)N(R)₂, N(R)N(R)C(O)R, N(R)N(R)C(O)OR, N(R)N(R)CON(R)2, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(.dbd.NH)N(R)₂, C(O)N(OR)R, and C(.dbd.NOR)R, wherein R can be hydrogen or a carbon-based moiety; for example, R can be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbon atoms or, in some embodiments, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “acyl” as used herein refers to a group containing a carbonyl moiety wherein the group is bonded via the carbonyl carbon atom. The carbonyl carbon atom is bonded to a hydrogen forming a “formyl” group or is bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. An acyl group can include 0 to about 12, 0 to about 20, or 0 to about 40 additional carbon atoms bonded to the carbonyl group. An acyl group can include double or triple bonds within the meaning herein. An acryloyl group is an example of an acyl group. An acyl group can also include heteroatoms within the meaning herein. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “aryl” as used herein refers to cyclic aromatic hydrocarbon groups that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, a phenyl group substituted at any one or more of 2-, 3-, 4-, 5-, or 6-positions of the phenyl ring, or a naphthyl group substituted at any one or more of 2- to 8-positions thereof.

The term “heterocyclyl” as used herein refers to aromatic and non-aromatic ring compounds containing three or more ring members, of which one or more is a heteroatom such as, but not limited to, N, O, and S.

The terms “halo,” “halogen,” or “halide” group, as used herein, by themselves or as part of another substituent, mean, unless otherwise stated, a fluorine, chlorine, bromine, or iodine atom.

The term “hydrocarbon” or “hydrocarbyl” as used herein refers to a molecule or functional group that includes carbon and hydrogen atoms. The term can also refer to a molecule or functional group that normally includes both carbon and hydrogen atoms but wherein all the hydrogen atoms are substituted with other functional groups.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof. Hydrocarbyl groups can be shown as (Cₐ-C_{b})hydrocarbyl, wherein a and b are integers and mean having any of a to b number of carbon atoms. For example, (C₁-C₄) hydrocarbyl means the hydrocarbyl group can be methyl (C₁), ethyl (C₂), propyl (C₃), or butyl (C₄), and (C₀-C_{b})hydrocarbyl means in certain embodiments there is no hydrocarbyl group.

The term “cure” as used herein refers to exposing to heat in any form, heating, or allowing to undergo a physical or chemical reaction upon heating that results in hardening or an increase in viscosity. A thermoplastic polymer or material or composition can be cured by heating and/or melting such that the material hardens upon cooling to a temperature below its Tg.

The term “solvent” as used herein refers to a liquid that can dissolve a solid, liquid, or gas. Non-limiting examples of solvents are silicones, organic compounds, water, alcohols, ionic liquids, and supercritical fluids.

The term “transparent” refers to an article that may be transparent to various wavelengths of visible light and, or various wavelengths of infrared light.

The term “translucent” refers to articles that may be semi-transparent to various wavelengths of visible light and, or various wavelengths of infrared light, or semi-transparent to various wavelengths of visible light, and transparent to various wavelengths of infrared light.

The term “glass transition temperature” (“Tg”) is the temperature at which an amorphous solid becomes soft upon heating or brittle upon cooling. The glass transition is lower than the melting point of its crystalline form, if it has one. The glass transition temperature of an amorphous thermoplastic polymers is gradual and referred to as a transition with a starting point transition temperature, a n inflection point temperature (centered in the transition phase), and an end point transition temperature, at the end of the transition phase or curve. The Tg values stated in this document are the Tg at the inflection point unless otherwise noted.

The term “rubbery plateau” refers to a region in which a nearly constant modulus in the region above (higher) than the glass transition temperature (Tg) and below (lower than) the melting temperature (Tm) exits ATM and can be observed on a DCS or TMA graph measuring Tg and Tm. It is the temperature region between the Tg and Tm when the amorphous polymer has softened but remains hard enough or stiff enough to maintain its original shape as is well known by those of ordinary skill in the art.

The term “Coefficient of Thermal Expansion” (“CTE’) or “Coefficient of Linear thermal Expansion” (“CTE” or “CTLE”) is a material property that is indicative of the extent to which a material expands upon heating which is well known to those of ordinary skill in the art. The CTE of the materials and compositions used and described herein were measured with a thermomechanical analyzer in accordance with AST Test Method E831, or as otherwise noted herein. The CTE can be recorded using a variety of calculations, including parts per million (ppm) as is well known by those of ordinary skill in the art. The CTE can also be measured quantitatively by simply measuring the dimensional changes of a mold article after exposure to time and temperature. For example the dimensional changes of a molded plaque may be measured using an appropriate measuring instrument, such as a ruler or caliper, the dimensional changes of such a molded plaque being measured in length, width, or thickness, or all three dimensions.

As used herein, the term “polymer” refers to a molecule having at least one repeating unit and can include copolymers.

All ranges and ratio limits disclosed in the specification may be combined. It is to be understood that unless specifically stated otherwise, references to “a,” “an,” and/or “the” may include one or more than one and that reference to an item in the singular may also include the item in the plural.

### EXAMPLES

In order to demonstrate the practice of the present invention, the following examples have been prepared and tested. The examples should not, however, be viewed as limiting the scope of the invention. The claims will serve to define the invention.

Test methods, procedures, and standards that may be referenced herein are: ASTM D542-2014, Standard Test Method for Index of Refraction of Transparent Organic Plastics; ASTM D1003-2013, Standard Test Method for Haze and Luminous Transmittance of Transparent Plastics; ASTM E1131-2008, Thermogravimetric Analysis; ASTM E1356-2014, Test Method to Determine Glass Transition of Plastics using differential scanning colorimetry (“DSC”) or Differential Scanning Analysis (“DSC”); ASTM D3418, Transition Temperatures; ASTM D696-2016, ASTM E831-2014, ASTM E1545-2016 related to measuring the glass transition temperatures and coefficient of thermal expansion of filled and unfilled plastics; ASTM D4464, Particle Size Distribution; Department of Defense, Index of Specifications and Standard, Federal Supply Class listing, (FSC) Part III, Nov. 1, 2005; An Index of US Voluntary Engineering Standards, Supplement 2; U.S. Department of Commerce, William J. Slattery, National Bureau of Standards, 1975-pagina’s 467; TEM, Transmission Electron Microscopy, Microscope, and related methods is the preferred method for measuring the size and characterizing particles or particulates including in situ in the molded composite thermoplastic molding material compositions; SEM, Scanning Electron Microscope, and related methods for measuring and characterizing particles, and can measure particulates and can measure particulates in situ on the surface of the molded composite thermoplastic molding material compositions; and ASTM E1225-04, Thermal Conductivity.

### Example 1

CONTROL COMPOSITION, SAMPLE A: Polyetherimide amorphous thermoplastic, EXTEM® XH1015 - 100%, no additives.

Step 1: Take EXTEM XH 1015 thermoplastic polyetherimide powder and screen out fine particles below 350 mesh. Dry fine, screened EXTEM powder in a vacuum oven for 4 hours at 170° C.

Step 2: Stack two 0.025 inch × 1.5 inch diameter thick steel washer on top of each other and set on a 3 inch square 0.03 inch thick. 3 inch square polished aluminum sheet. Fill steel washer mold with EXTEM ®XH1015 polyetherimide blend. Place another 0.03 inch thick × 3 inch square polished aluminum plate on top of the bottom assembly and compression mold (230° C. for 2 minutes, 250° C. for 2 minutes, 270° C. for 2 minutes, 290° C. for 1 minute. Remove compression molded plaques. Place a 3 inch square by 0.03 inch thick PTFE porous fabric piece on the same size polished aluminum plate (above, place compression molded plaque on the PTFE fabric, Place the same size PTFE fabric sheet (above) on top of the molded plaques and place another same size polished aluminum plate on top of the PTFE fabric. Compression mold again at same temperatures/times as above. The porous PTFE fabric will devolatize any volatiles and moisture and provide a uniformly molded plaque about 0.025 or so inches thick and about 2 inches in diameter. The molded plaque has a textured surface with very excellent detail and is transparent.

### Comparative Composition, Sample Spi-001-a

Step 1: prepare an Additive Composition: SP-001A Additive 27.0 grams phenyl silicone resin, Silres 603 phenyl silicone solid flakes. Grind the Silres 603 resin coarse powder, then screen out fine particles, below 325 mesh.

Step 2: Take EXTEM XH 1015 thermoplastic polyetherimide powder and screen out fine particles below 350 mesh. Dry fine, screened EXTEM powder in a vacuum oven for 4 hours at 170° C.

Step 3: Let EXTEM XH 1015 dried powder cool to ambient temperature in vacuum oven, blend 0.4 grams HTLT SPI-001 Additive into 9.8 grams EXTEM AH 1015, dried, fine powder and blend thoroughly.

Step 4: Stack two 0.025 inch × 1.5 inch diameter thick steel washer on top of each other and set on a 3 inch square 0.03 inch thick. 3 inch square polished aluminum sheet. Fill steel washer mold with EXTEM/HTLT SPI-001 Additive/ polyetherimide blend. Place another .03 inch thick × 3 inch square polished aluminum plate on top of the bottom assembly and compression mold (230° C. for 2 minutes, 250° C. for 2 minutes, 270° C. for 2 minutes, 290° C. for 1 minute. Remove compression molded plaques. Place a 3 inch square by 0.03 inch thick PTFE porous fabric piece on the same size polished aluminum plate (above, place compression molded plaque on the PTFE fabric, Place the same size PTFE fabric sheet (above) on top of the molded plaques and place another same size polished aluminum plate on top of the PTFE fabric. Compression mold again at same temperatures/times as above. The porous PTFE fabric will devolatize any volatiles and moisture and provide a uniformly molded plaque about 0.025 or so inches thick and about 2 inches in diameter. The molded plaque has a textured surface with very excellent detail and is transparent.

### Comparative Composition, Sample Spi-001-b

Make another plaque exactly the same way as sample SPI-001-A except using 0.2 grams HTLT SPI-001 Additive and 9.8 grams EXTEM® XH 1050, fine powder.

### Comparative Composition, Sample C

Make another plaque exactly the same way as sample SPI-001-B, except use Sample C Additive:

| % | (by Weight of Thermoplastic Host Resin) |
|---|---|
| 10.2 | INT 40DHT, fatty acid/gylceride, Axel Laboratories |
| 6.8 | Silres 604, pheny methyl silicone resin, Wacker Corp. |
| 10.2 | Silres 603, phenyl silicone resin, Wacker Corp. |
| 50.8 | POSS SO 1458, Hybrid Plastics |
| 8.4 | ERL 4221 Cycloaliphatic Epoxide, Union Carbide |
| 13.6 | ALUC 805, Evonik Degussa Co., surface treated w. 3% KZ55, zirconate, Kenrich |

Chemicals
100%

Make the Sample C Composition using 0.2 grams Sample C Additive (void of phenyl silicone resin)and 9.8 grams EXTEM® XH 1050, fine powder.

DSC: Instrument: TA Instruments Q Advantage with Q200 Differential Scanning Calorimeter. Gas: Nitrogen @ 60 cc/minute. Temperature Program: Equilibrate at 30° C., Ramp 20° C./min to 350° C., Isothermal for 1.00 min, Ramp 20° C./min to 30° C., Isothermal for 1.00 min, Equilibrate at 30° C., Ramp 20° C./min to 350° C., Isothermal for 1.00 min, Ramp 20° C./min to 30° C., Isothermal for 1.00 min. ASTM E1356-2014,

### Test Results:

The test results are summarized below. Tg values are for the inflection point:

Chart #1:

| Sample ID | |
|---|---|
| | 2^{nd} ramp Tg @ inflection Point |
| Control Sample A | 260.33° C. |
| Comparative Sample C | 259.40 |
| Comparative Sample: SPI-001-A | 266.84° C. |
| Sample: SPI-001-B | 264.21° C. |

The Tg of Sample A (Control/ no additives) is essentially the same as the Tg of Sample C which is comprised of the same additives as Comparative Additives as Comparative Samples SPI-001-A and SPI-001-B except Sample C additive is void of silicone resins. The Tg of the Comparative Samples SPI-001-A and SPI-001-B increased and outperformed the Control Sample A, and the Tg increased with increasing amounts of the silicone resin.

### Example 2

A thermoplastic composition and an injection molded, transparent plaque, having a dimension of about 20 mm square x 2.0 mm thick, according to the invention described herein was produced by first making an additive composition as follows:

TABLE 1

Additive Produced:
Additive Code Name: E-60
% (by Weight of Thermoplastic Host Resin)
0.05 INT 40DHT, fatty acid/gylceride, Axel Laboratories
0.04 Silres 604, pheny methyl silicone resin, Wacker Corp.
0.06 Silres 603, phenyl silicone resin, Wacker Corp.
0.05 Doverphos 9228PC, Dover Chemical
0.05 Mayzo 168, Mayzo Corp.
0.3 POSS SO 1458, Hybrid Plastics
0.1 KZ55, zirconate, Kenrich Chemicals
0.05 ERL 4221 Cycloaliphatic Epoxide, Union Carbide
0.08 ALUC 805, Evonik Degussa Co.
0.78 Total % Additive According to Invention by total weight of Thermoplastic Composition, Table 2 below.

Intergrind and mix blend all of the above additive components together using a high speed blender, grinder, and mixer such as a Henschel mixer or equivalent.

TABLE 2

Thermoplastic Composition Produced:
Thermoplastic Composition Code Name: E-60
% (by Weight of Thermoplastic Host Resin)
0.78% Additive, Code Name E-60, Table 1, Example 1
99.22% EXTEM® XH 1015 Polyamide/Polyetherimide Thermoplastic Pellets
100 % Total Weight of Thermoplastic Composition Code Name E-60.

The thermoplastic composition, Code Name E-60, of Table 2 was produced by (i) drying the Extern® XH 1015 resin pellets at 170° C. for 4 hours to a moisture level of 0.02% or less., (ii) melt compounding all of the components of Table 2 in a 26 mm Thermo-Scientific Compounder at a melt temperature of 360° C., cooling the melted strands from the compounder dye in a water bath, and pelletizing the strands into 1 to 2 mm pellets. The pellets were dried again in a vacuum drier at 200° C. for 1.5 hours and 170° C. for 2.5 hours.

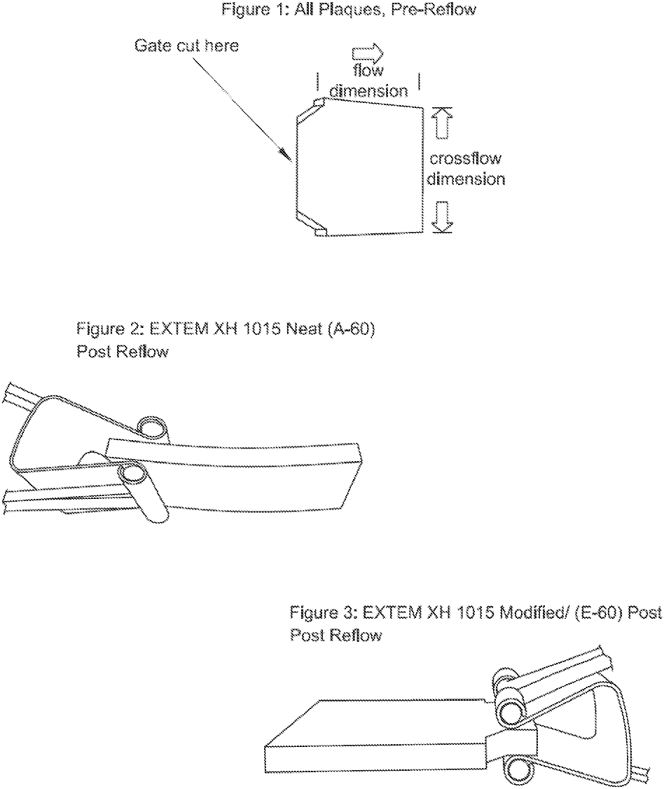

Plaques, about 2 mm thick by 20 mm square (FIG. 1), from each of the thermoplastic composition pellets were made by injection molding at 380° C. in a V-Line injection molding machine with a mold temperature of 172° C.

For comparative purposes, the neat (no additives), host Extem®XH1015 thermoplastic resin, Code Name A-60 was dried and compounded as above, produced into pellets, dried, and plaques of the same size were made by injection molding as above.

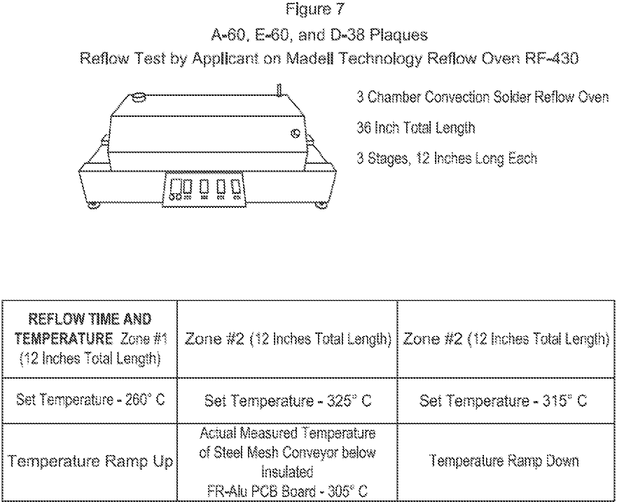

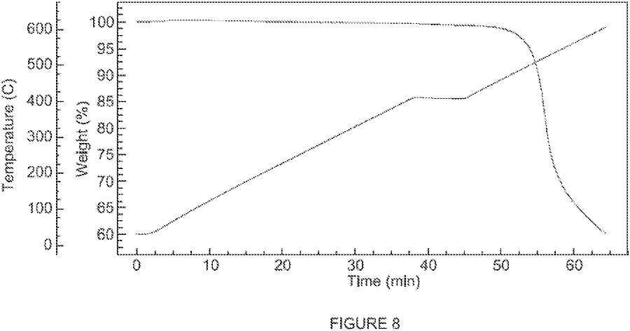

The plaques were measured comparatively for dimensional stability and expansion after thermal exposure in a solder reflow oven at 300° C., and shown in FIGS. 2, and 3. For the Reflow tests, used a 3 chamber Madell Technology Reflow Oven. A photo of the oven and the Reflow and related testing information are shown in FIG. 7.

TABLE 3

Geometric Measurements Pre/ Post Reflow for Plaques A-60 & E-60*

| Plaque: | Pre/Post Reflow | Flow (mm) | Change (%/ mm) | Crossflow (mm) | Change (%/mm) | Thickness (mm) | Change (%/ mm) |
|---|---|---|---|---|---|---|---|
| A-60 | Pre-Reflow | 20.040 | | 21.8948 | | 2.032 | |
| | Post Reflow | 19.329 | -3.55/ -0.711 | 21.9964 | +0.464/ +0.102 | 2.1082 | +3.74/+0.076 |
| E-60 | Pre-Reflow | 20.040 | | 21.8948 | | 2.032 | |
| | Post Reflow | 20.015 | -0.12/ -0.025 | 21.9075 | +0.06/ +0.013 | 2.032 | 0.0 |
| Plaque: | Pre/Post Reflow | Warp (Visual) | Warp Depth (mm) | | | | |
| A-60 | Pre-reflow | Flat | 0.0 | | | | |
| | Post Reflow | Warped | 1.35 mm | | | | |
| E-60 | Pre-Reflow | Flat | 0.0 | | | | |
| | Post Reflow | No Warp | 0.0 | | | | |

* Both A-60 (control) and E-60 plaques were produced at 380° C. barrel temperature, 60 second cycle times, 2 minute residence times, equal injection pressures, and 170° C. mold temperature. As shown in Table 3, the plaques, Code Named E-60, produced from the inventive Thermoplastic Composition, Code Name E-60 from Table 2 above, were far more geometrically stable than the comparative composition and plaques Code named A-60. Plaque, Code Named E-60, Figure C, containing the Additives of Table 1, showed no visible warping, after thermal exposure of 300° C., a temperature far exceeding the Tg of the comparable A-60 plaque, Figure B, which has a Tg of about 260° C. in pellet form prior to injection molding. Plaque A-60 in Figure B showed high visible warping. The E-60 plaques showed much lower dimensional change in all directions, flow, cross-flow, and thickness than the A-60 plaques after the 300° C. exposure in a reflow oven as shown in Table 3. It is surprising and unexpected that Plaque E-60 made from the thermoplastic composition of Table 2 can be so significantly thermally stable and dimensionally stable than the comparative Plaque A-60. The performance of Plaque E-60 demonstrates the significant improvement in Tg and CTE compared to plaque A-60 (control).

### Example 3

A thermoplastic composition and an injection molded plaque, having a dimension of about 20 mm square × 2.0 mm thick, according to the invention described herein was produced by first making an additive composition as follows:

TABLE 4

Additive Produced:
Additive Code Name: D-38 % (by Weight of Thermoplastic Host Resin)
0.066 INT 40DHT, fatty acid/gylceride, Axel Laboratories
0.213 Silres 603, phenyl silicone resin, Wacker Corp.
0.034 Doverphos 9228PC, Dover Chemical
0.034 Mayzo 168, Mayzo Corp.
0.200 POSS SO 1458, Hybrid Plastics
0.022 ERL 4221 Cycloaliphatic Epoxide
0.054ALUC 805, Evonik Degussa Co.
0.589 Total % Additive According to Invention by total weight of Thermoplastic Composition, Table 5 below.

Intergrind and mix blend all of the above additive components together using a high speed blender, grinder, and mixer such as a Henschel mixer or equivalent.

TABLE 5

Thermoplastic Composition Produced:
Thermoplastic Composition Code Name: D-38 % (by Weight of Thermoplastic Host Resin)
0.589% Additive, Code NameD-38, Table 4, Example 2
99.411% EXTEM® XH 1015 Polyamide/Polyetherimide Thermoplastic Pellets
100 % Total Weight of Thermoplastic Composition Code Name E-60.

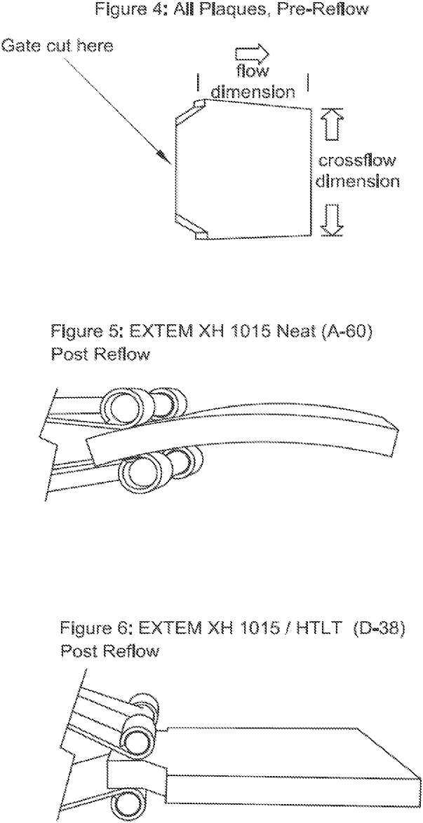

The thermoplastic composition, Code Name D-38, of Table 2 was produced by (i) drying the Extem XH 105 resin pellets at 170° C. for 4 hours to a moisture level of 0.02% or less., (ii) melt compounding all of the components of Table 2 in a 26 mm Thermo-Scientific Compounder at a melt temperature of 360° C., cooling the melted strands from the compounder dye in a water bath, and pelletizing the strands into 1 to 2 mm pellets. The pellets were dried again in a vacuum drier at 200° C. for 1.5 hours and 170° C. for 2.5 hours. Plaques, about 2 mm thick by 20 mm square (FIG. 4), from each of the thermoplastic composition pellets were made by injection molding at 380° C. in a V-Line injection molding machine.

For comparative purposes, the neat (no additives), host Extem®XH 1015 thermoplastic resin, Code Name A-60 was dried and compounded as above, produced into pellets, dried, and transparent plaques of the same size were made by injection molding as above.

The plaques were measured comparatively for dimensional stability after thermal exposure in a solder reflow oven at 300° C., and shown in FIGS. 5, and 6.

For the Reflow tests, a 3 chamber Madell Technology Reflow Oven was used. A photo of the oven and the Reflow and related testing information are shown in FIG. 7 below.

TABLE 6

Geometric Measurements Pre/ Post Reflow for Plaques A-60 & D-38*

| Plaque: | Pre/Post Reflow | Flow (mm) | Change (%/ mm) | Crossflow (mm) | Change (%/mm) | Thickness (mm) | Change (%/ mm) |
|---|---|---|---|---|---|---|---|
| A-60 | Pre-Reflow | 19.960 | | 21.870 | | 2.030 | |
| (top edge) | Post Reflow | 19.450 | -2.55/-0.51 | 22.270 | +0.1.9/ +0.42 | 2.160 | +6.4/+0.13 |
| (bot. edge) | | 19.741 | -4.25/-0.85 | | | | |
| D-38 | Pre-Reflow | 19.960 | | 21.880 | | 2.040 | |
| | Post Reflow | 19.890 | -0.35/ -0.07 | 21.960 | +0.08/ +0.36 | 2.050 | +0.49/+0.01 |
| Plaque: | Pre/Post Reflow | Warp (Visual) | Warp Depth (mm) | | | | |
| A-60 | Pre-reflow | Flat | 0.0 | | | | |
| | Post Reflow | Warped | 1.09 mm | | | | |
| D-38 | Pre-Reflow | Flat | 0.0 | | | | |
| | Post Reflow | No Warp | 0.0 | | | | |

*Both A-60 (control) and D-38 plaques were produced at 380° C. barrel temperatures, equal injection pressures, and 170° C. mold temperature. The A-60 plaques were produced with a 60 second cycle time and a 120 second residence time. The D-38 plaques were produced with a 38 second cycle time and a 76 second residence time. As shown in Table 6, the plaques, Code Name D-38, produced from the inventive Thermoplastic Composition, Code Name D-38 from Table 4 above, were far more geometrically stable than the comparative composition and plaques Code named A-60. Plaque, Code Named D-38, Figure F, containing the Additives of Table 4, showed no visible warming, after thermal exposure of 300° C., a temperature far exceeding the Tg of the comparable A-60 plaque, Figure E, which has a Tg of about 260° C. in pellet form prior to injection molding. Plaque A-60 in Figure E showed high visible warping. The D-38 plaques showed much lower dimensional change in all directions, flow, cross-flow, and thickness than the A-60 plaques after the 300 degree C exposure in a reflow oven as shown in Table 6. It is surprising and unexpected that Plaque D-38 made from the thermoplastic composition of Table 5 can be so significantly thermally stable and dimensionally stable than the comparative Plaque A-60. The performance of Plaque D-38 demonstrates the significant improvement in Tg and CTE compared to plaque A-60 (control).

TABLE 7

Plaque # D-38/ TGA/ ASTM E1131-2008/ TGA: TA Instruments Q Advantage with Q50
Thermogravimetric Analyzer. Gas: Nitrogen to 600° C. / Air from 600° C. to 800° C. Gas
Flow Rate: 60 cc/minute. Temperature Ramp Rate: 20° C./minute to 800° C., isothermal 5 minutes at 800° C. Method: Standard Rubber Analysis.

### Summary of Test Conditions & Results

Plaque # D-38 was tested for thermal stability, the results are listed below and shown in FIG. 8.
Sample size 11.528 mg, undried.
Ramp temperature 10° C./minute to 400° C. (approx. 38 minutes),
Hold temperature at 400° C. for 7 minutes,
Ramp temperature from 400° C. to 600° C. at 10° C. per minute.
Graph #1, plot Temperature and Weight Loss (%) vs. Time.
Graph #2, plot Weight Loss (%) vs. Temperature.
Loss on Weight only 2% demonstrating that even a small article, such as a lens, weighing only11.528 grams can be injection molded at a temperature of 400° C. or higher for a residence time of 7 minutes without any degradation or loss of integrated properties, and is thermally stable to 500° C.

TABLE 8

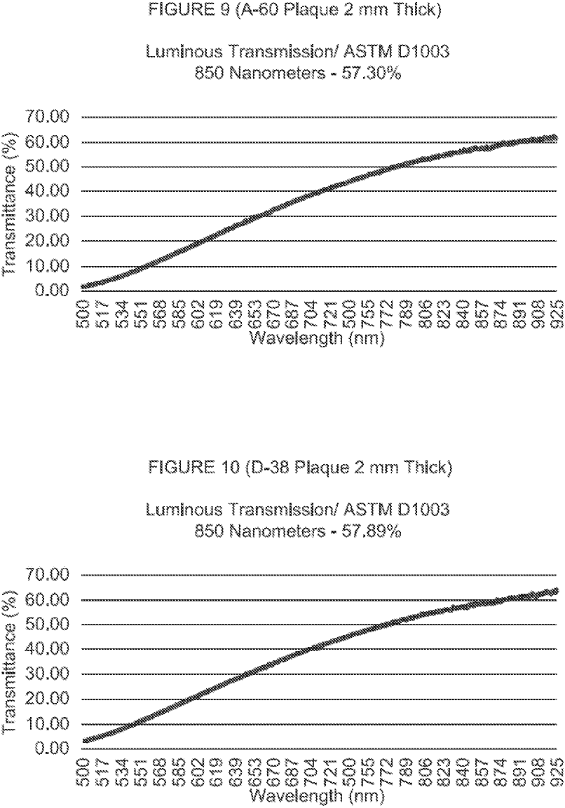

Light Transmission Tests (ASTM D1003)

| | |
|---|---|
| FIG. 9 (A-60 Plaque, 2 mm Thick) Luminous Transmission 850 nm - 57.30 | FIG. 10 (D-38 Plaque, 2 mm Thick) Luminous Transmission 850 nm - 57.89 % |

It is surprising and unexpected that the 2.0 mm thick D-38 plaque of Example 2 has a higher luminous transmission than the luminous transmission of the 2.00 mm thick A-60 plaque of Example 2. Light transmission measurements performed in accordance with ASTM D1003, Standard Test Method for Haze and Luminous Transmittance of Transparent Plastics.

### Cte and Tg Measurements of Plaque Specimens From A-60 Plaque and D-38 Plaque Example 2

Two specimens of material were measured for analysis of the Coefficients of Thermal Expansion and the glass transition temperature (Tg). The samples were labeled as “A-60” and “D-38”. The samples were provided in moisture barrier bags with desiccant packs to minimize water absorption into the polymer. Two specimens were cut from the samples for analysis in the flow and cross flow direction. Each of the specimens were measured with thermomechanical analysis (TMA) from 60° C. to 300° C. in two heating cycles. The first cycle was used to release residual stresses in the plastic and the second cycle was used for the precision measurement of CTE. The results of the TMA evaluation are presented in Table 8.

TABLE 9

CTEs determined from TMA for each specimen.

| Specimen | 70 to 235° C. CTE (ppm/°C) | 100° C. CTE (ppm/°C) | 150° C. CTE (ppm/°C) | 200° C. CTE (ppm/°C) | Tg (°C) |
|---|---|---|---|---|---|
| A 60 flow | 49.2 | 46.0 | 51.9 | 55.0 | 259 |
| A 60 crossflow | 50.0 | 46.6 | 49.9 | 55.7 | 260 |
| D-38 flow | 41.8 | 36.4 | 39.1 | 45.5 | 262 |

### Tma Methods and Results

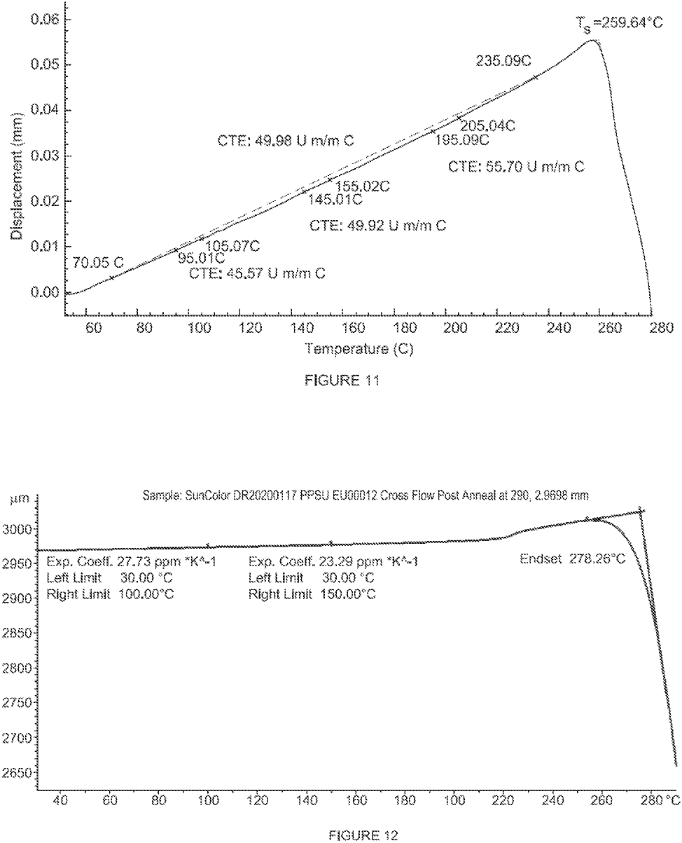

TMA data were collected on a TA Instruments Model 943 thermomechanical analyzer controlled Instrument Specialists Inc (ISI) Windows based software package. The sample analyzed based on ASTM E831 and ASTM E1545. Each specimen was heated from 60° C. to 300° C. at 5° C./min under a load of 1 g (~10 mN) and a flow of dry nitrogen at 25 mL/min. Once the specimen began to soften on the initial temperature ramp, the loading weight was removed, and the sample was allowed to cool back to 60° C. before being replacing the loading weight and heated again. A blank run was collected and subtracted from the 2^{nd} heat data in order to eliminate the contribution from the fixture expansion from the data for more accurate CTE determination. CTEs at specific temperatures along with the Tg for each specimen have been annotated and presented in Table 8. Flow specimens: 6.0 mm; Crossflow specimens, 5.6 mm. It is surprising and unexpected that the D-38 flow specimen taken from the D-38 plaque of Example 2 has a significantly lower CTE(s) than the A-60 flow specimen taken from the A-60 flow specimen taken from the A-60 plaque of Example 2. It is also surprising and unexpected that the D-38 crossflow specimen taken from the D-38 plaque of Example 2 has a significantly higher Tg than the A-60 crossflow specimen taken from the A-60 plaque of Example 2. TMA graphs for A-60 (control) test specimens in cross-flow and D-38 test specimens in cross flow are shown in FIG. 11 and FIG. 12.

### Example 4

Comparative Tg and CTE data for the following thermoplastics and thermoplastic composition:
Control Sample:
Sample A: 100 % polyether PPSU, Radel® R 5000.
Sample B: Composition made in the exact way as Example 2 sample E-60 except the mold temperature was 182° C.

TABLE 10

| Sample B Additive Formula: Additive Composition: | |
|---|---|
| | % |
| Silres 603 Silicone Resin | 0.20 |
| ALU C Aluminium Oxide Surface Treated w. Zirconate/Tyzor 212 (3%) | 0.18 |
| ERL 4221 Cycloaliphatic Epoxide | 0.02 |
| Trisilanolphenyl POSS 1458 | 0.10 |
| INT40DHT Fatty Acid-Glyceride | 0.02 |
| | 0.52% |

0.52% by weight of Radel R 5000 pellets

TABLE 11

Sample B Thermoplastic Composition:

| Thermoplastic Composition: | % |
|---|---|
| (Code Name HTLT 000012) | |
| Radel R 5000 PPSU pellets | 99.48 |
| Silres 603 Silicone Resin | 0.20 |
| ALU C Aluminium Oxide Surface Treated w. Zirconate/Tyzor 212 (3%) | 0.18 |
| ERL 4221 Cycloaliphatic Epoxide | 0.02 |
| Trisilanolphenyl POSS 1458 | 0.10 |
| INT40DHT Fatty Acid-Glyceride | 0.02 |
| | 100% |

### Test Results:

Sample A: The Tg of Radel R 5000 is reported by its manufacturer to be 220° C. at the inflection point (ASTM E1356). The CTE or CTLE of the Radel R 5000 is reported by its manufacturer to be 55.6 ppm (ASTM D696).

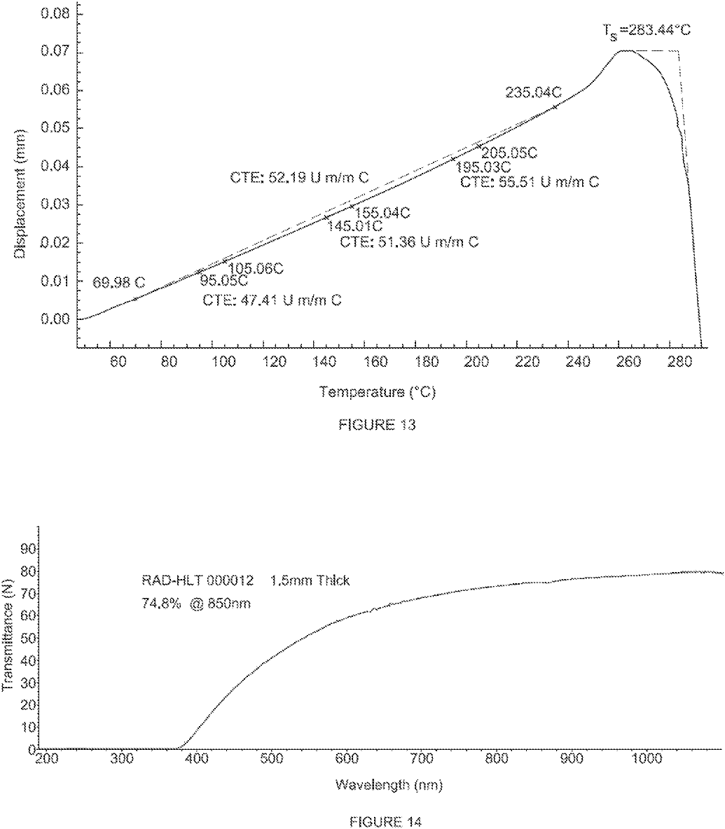

Sample B (code name HTLT 000012): The Tg and CTE were measured by TMA (ASTM E831). The Tg at the end point was 278.26. The CTE from 30° C. to 150° C. was 23.29 ppm. Tg and CTE results are shown in FIG. 13. The light transmission of a plaque 1.5 mm thick was 74.8% at 850 nm, shown in FIG. 14, measured in accordance with ASTM D1013.

While the invention has been described with reference to various embodiments, it is to be understood that various modifications may become apparent to those skilled in the art upon reading the specification. Therefore, it is to be understood that the invention includes all such modifications that may fall within the scope of the appended claims.

1. A molding composition comprising:
(i) a thermoplastic resin; and
(ii) from about 0.005 to about 10 parts by weight, per 100 parts by weight of the thermoplastic resin, of a polysiloxane, where the polysiloxane includes phenyl substituents, and where the molding composition has a glass transition temperature at least 1% higher than the Tg of the thermoplastic resin.

2. The molding composition of claim 1, where the polysiloxane has a glass transition temperature of greater than 50° C.

3. The molding composition of claim 1, where the polysiloxane has a molecular weight of from about 800 to about 6.000 g/mole.

4. (canceled)

5. The molding composition of claim 1, where the polysiloxane is a polydiphenylsiloxane, a poly(methyl) (phenyl)siloxane, or a mixture of a polydiphenylsiloxane and a poly(methyl) (phenyl)siloxane.

6. The molding composition of claim 1, where the polysiloxane includes at least one functional group selected from the group consisting of hydroxyl, silanol, and alkoxy functional groups.

7. The molding composition of claim 1, where the composition includes greater than 70 wt % thermoplastic resin.

8. (canceled)

9. The molding composition of claim 1, where the thermoplastic resin has a Tg of greater than 80° C.

10. The molding composition of claim 1, where the thermoplastic resin is selected from the group consisting of polyimide, polyetherimide, polysulfone, polyphenylsulfone, polycarbonate, or copolymers of the same, or a mixture of two or more of the same.

11. The molding composition of claim 1, where the composition further includes an additive selected from the group consisting of zirconates, titanates, curing synergist, a mixture of one or more zirconates and one or more titanates, inorganic particulates, biphenol, polyhedral oligomeric silsesquioxanes, and cycloaliphatic epoxy resins.

12. The molding composition of claim 1, where the molding composition includes from about 0.005 to about 1.0 parts by weight of the zirconate per 100 parts by weight of the thermoplastic resin, or where the molding composition includes from about 0.005 to about 1.0 parts by weight of the titanate per 100 parts by weight of the thermoplastic resin.

13. (canceled)

14. (canceled)

15. The molding composition of claim 1, where the molding composition includes from about 0.001 to about 6.0 parts by weight of the silsesquioxane per 100 parts by weight of the thermoplastic resin.

16. The molding composition of claim 1, where the molding composition includes from about 0.001 to about 1.0 parts by weight of the biphenol per 100 parts by weight of the thermoplastic resin, or where the molding composition includes from about 0.001 to about 1.0 parts by weight of the cycloaliphatic epoxy resin per 100 parts by weight of the thermoplastic resin.

17. (canceled)

18. (canceled)

19. The molding composition of claim 11, where the inorganic particulates are selected from the group consisting of aluminum oxide, silicon dioxide, and a mixture of aluminum oxide and silicon dioxide.

20. The molding composition of claim 1, in which the inorganic particulates have a thermal conductivity value greater than the thermal conductivity value of the thermoplastic resin.

21. The molding composition of claim 1, where the polyhedral oligomeric silsesquioxane is a trisilanol phenyl oligomeric silsesquioxane.

22. An article molded from the molding composition of claim 1, where the article is transparent or translucent.

23. (canceled)

24. (canceled)

25. A method for forming a molded article, the method comprising:
thermally molding the molding composition of claim 1.

26. The molding composition of claim 1, where the molding composition includes from about 0.1 to about 10 parts by weight, per 100 parts by weight of the thermoplastic resin, of an inorganic particulate, where said inorganic particulate has an average particle size up to 500 nm or is in the form of an aggregate having a median particle size up to 700 nm.

27. The article of claim 22, where the article is a lens.

28. The article of claim 27, where the article is translucent and has an embossed or textured surface.

29. The molding composition of claim 1, where the polysiloxane is a solid at normal temperature and pressure and has a dynamic viscosity of less than 100 mPa·s in the range of 65 to 85° C.

30. The article of claim 22, where the article is transparent and has a thickness of 0.1 millimeters or greater, has a luminous light transmission of at least 50% at one or more wavelengths of 450 nm, 500 nm, 600 nm, 700 nm, 750 nm, 800 nm, 850 nm, 900 nm, 1000 nm, and at a wavelength between 450 to 1000 nanometers.
